(19) United States
(12) Patent Application Publication
(10) Pub. No.: US 2009/0046053 A1
(43) Pub. Date: Feb. 19, 2009

(54) IMAGE DISPLAYING MEDIUM AND IMAGE DISPLAY DEVICE

(75) Inventors: Kiyoshi SHIGEHIRO, Kanagawa (JP); Yoshinori MACHIDA, Kanagawa (JP); Yasufumi SUWABE, Kanagawa (JP); Satoshi TATSUURA, Kanagawa (JP); Masaaki ABE, Kanagawa (JP); Ryojiro AKASHI, Kanagawa (JP); Daisuke NAKAYAMA, Minamiashigara-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/189,958

(22) Filed: Aug. 12, 2008

(30) Foreign Application Priority Data
Aug. 13, 2007 (JP) 2007-210913

(51) Int. Cl. G09G 3/34; B32B 5/16

(52) U.S. Cl. 345/107; 428/411.1; 428/304.4

(57) ABSTRACT

An image display medium including a pair of substrates, a dispersion medium, and particles of two or more kinds, the particles of each kind being able to move in the dispersion medium in response to an electric field formed between the substrates, each kind of particles having a different color and a different absolute value of a voltage for moving, the voltage for moving being determined from a difference between an electrostatic force that acts on the particles in response to the electric field formed between the substrates and a binding force that acts in a direction of retaining the particles in a state that the particles are in before the electrostatic force acts on the particles, and at least one of an intensity of the binding force and an intensity of the electrostatic force for the particles of each kind being different.

### CROSS-REFERENCE TO RELATED APPLICATION

This application is based on and claims priority under 35 USC 119 from Japanese Patent Application No. 2007-210913 filed Aug. 13, 2007.

### BACKGROUND

1. Technical Field

The present invention relates to an image display medium and an image display device, and in particular relates to an image display medium and an image display device that display an image by the movement of particles.

2. Related Art

Conventionally, display technologies employing the mechanism of electrophoresis has been proposed for a sheet-like rewritable image display medium.

### SUMMARY

According to an aspect of the invention, there is provided an image display medium comprising:

a pair of substrates placed to face each other with a space therebetween, at least one of the substrates having transparency;

a dispersion medium positioned between the substrates, the dispersion medium having transparency; and

particles of two or more kinds dispersed in the dispersion medium, the particles of each kind being able to move in the dispersion medium in response to an electric field formed between the substrates, each kind of particles having a different color and a different absolute value of a voltage for moving that is necessary for the particles to move,

the voltage for moving being determined from a difference between an electrostatic force that acts on the particles in response to the electric field formed between the substrates and a binding force that acts in a direction of retaining the particles in a state that the particles are in before the electrostatic force acts on the particles,

an intensity of the binding force for the particles of each kind being selected from a predetermined intensity of a first binding force and an intensity of a second binding force that is different from the intensity of the first binding force,

an intensity of the electrostatic force for the particles of each kind being selected from a predetermined intensity of a first electrostatic force and an intensity of a second electrostatic force that is different from the intensity of the first electrostatic force, and

at least one of the intensity of the binding force and the intensity of the electrostatic force for the particles of each kind being different.

### BRIEF DESCRIPTION OF THE DRAWINGS

Embodiments of the present invention will be described in detail based on the following figures, wherein:

FIG. 1 is a schematic view of the image display device according to a first exemplary embodiment of the invention;

FIG. 2 is a diagram schematically showing the relationship between the applied voltage and the amount of particle movement according to the first exemplary embodiment;

FIG. 3 is a drawing schematically showing the relationship between the embodiments of formation of an electric field in the image display medium and the embodiments of particle movement according to the first exemplary embodiment;

FIG. 4 is a table showing an example of information stored in the corresponding table 14A according to the first exemplary embodiment;

FIG. 5 is a table showing an example of information stored in the corresponding table 14B according to the first exemplary embodiment;

FIG. 6 is a flowchart showing the processing executed in the control unit according to the first exemplary embodiment;

FIG. 7 is a schematic view of the image display device according to a second exemplary embodiment of the invention;

FIG. 8 is a diagram schematically showing the relationship between the applied voltage and the amount of particle movement according to the second exemplary embodiment;

FIG. 9 is a drawing schematically showing the relationship between the embodiments of formation of an electric field in the image display medium and the embodiments of particle movement according to the second exemplary embodiment;

FIG. 10 is a table showing an example of information stored in the corresponding table 23A according to the second exemplary embodiment;

FIG. 11 is a table showing an example of information stored in the corresponding table 23B according to the second exemplary embodiment; and

FIG. 12 is a flowchart showing the processing executed in the control unit according to the second exemplary embodiment;

### DETAILED DESCRIPTION

### First Exemplary Embodiment

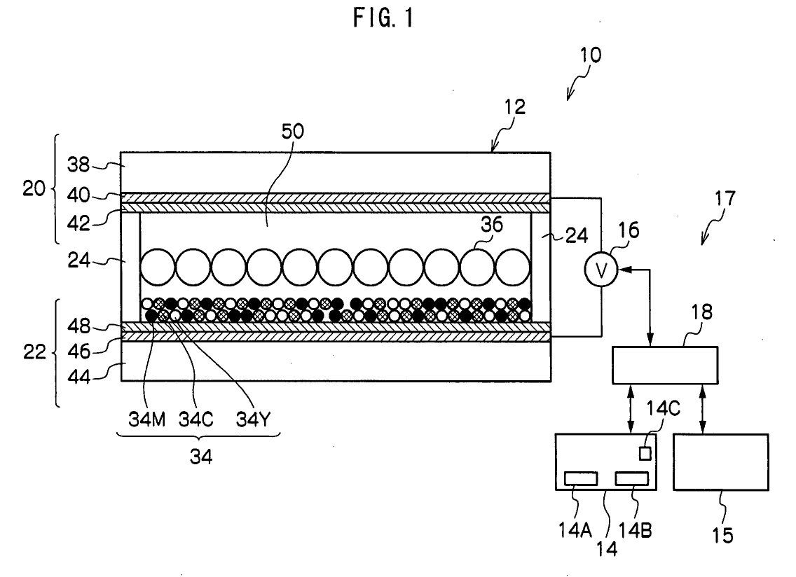

As shown in FIG. 1, an image display medium 12 according to the first exemplary embodiment of the invention comprises a display substrate 20 used as an image display surface, a rear substrate 22 disposed opposite to the display substrate 20 with a space therebetween, a space member 24 that maintains a predetermined amount of the space and divides the space between the display substrate 20 and the rear substrate 22 into plural cells, and particles 34 enclosed in the cells.

The above-described cell refers to a region surrounded by the display substrate 20, the rear substrate 22, and the space member 24. A dispersion medium 50 is enclosed in the cell. The particles 34 (described in detail later) are dispersed in the dispersion medium 50, and move between the display substrate 20 and the rear substrate 22 according to the intensity of an electric field formed in the cell.

The image display medium 12 can be configured to display the color of each pixel in a separate manner by forming the cells in order to correspond to each pixel by providing the space member 24 corresponding to each pixel when an image displayed on the image display medium 12.

The display substrate 20 has a structure in which a surface electrode 40 and a surface layer 42 are layered on a supporting substrate 38 in this order. The rear substrate 22 has a structure in which a rear electrode 46, and a surface layer 48 are layered on a supporting substrate 44 in this order.

Examples of the material for the supporting substrate 38 and the supporting substrate 44 include glass and plastics such as polycarbonate resins, acrylic resins, polyimide resins, polyester resins, epoxy resins, and polyether sulfone resins.

Examples of the material for the rear electrode 46 and the surface electrode 40 include oxides of indium, tin, cadmium, and antimony, complex oxides such as ITO, metals such as gold, silver, copper, and nickel, and organic conductive materials such as polypyrrole and polythiophene. These materials can be used as a single layer film, a mixed film, or a composite film, and can be formed by vapor deposition, sputtering, application or other appropriate methods. The thickness of the film formed by vapor deposition or sputtering is usually 100 to 2000 angstroms. The rear electrode 46 and the surface electrode 40 can be formed into a desired pattern, for example, into a matrix form or a stripe form which enables passive matrix driving, by a conventionally known method such as etching of conventional liquid crystal display elements or printed boards.

The surface electrode 40 may be embedded in the supporting substrate 38. In a similar manner, the rear electrode 46 may be embedded in the supporting substrate 44. In this case, the material for the supporting substrates 38 and 44 should be properly selected in consideration of the composition and other properties of the particles 34, since the material may affect the charging characteristics or flowability of each of the particles 34.

The rear electrode 46 and the surface electrode 40 may be disposed outside the image display medium 12, separately from the display substrate 20 and the rear substrate 22, respectively. In this case, since the image display medium 12 is disposed between the rear electrode 46 and the surface electrode 40, the distance between the rear electrode 46 and the surface electrode 40 increases and the electric field intensity decreases Accordingly, in order to obtain a desired intensity of an electric field, it is necessary to decrease the thickness of the supporting substrate 38 and the supporting substrate 44 substrate, or to decrease the distance between the supporting substrate 38 and the supporting substrate 44 in the display medium 12.

In the above-described case, the electrodes (surface electrode 40 and rear electrode 46) are provided to both of the display substrate 20 and the rear substrate 22, but it is also possible to provide only one electrode to either of the substrates.

In order to enable active matrix driving, the supporting substrate 38 and the supporting substrate 44 may be provided with a TFT (thin-film transistor) for each pixel. From the viewpoint of readily conducting lamination of wiring lines or mounting of components, the TFT is preferably formed on the rear substrate 22, rather than on the display substrate 20.

When the image display medium 12 is driven by a simple matrix system, the configuration of the image display device 10 including the image display medium 12, which will be described later, can be simplified. On the other hand, when the image display medium 12 is driven by an active matrix system using a TFT, the display speed can be increased compared with the case driven by a simple matrix system.

When the surface electrode 40 and the rear electrode 46 are formed on the supporting substrate 38 and the supporting substrate 44, respectively, it is preferable, as necessary, that a surface layers 42 and 48 that serve as a dielectric film are formed on the surface electrode 40 and the rear electrode 46, respectively, in order to prevent breakage of the surface electrode 40 and the rear electrode 46 or leakage occurring between the electrodes which may cause coagulation of the particles 34.

Examples of the material for the surface layer 42 and the surface layer 48 include polycarbonate, polyester, polystyrene, polyimide, epoxy, polyisocyanate, polyamide, polyvinyl alcohol, polybutadiene, polymethyl methacrylate, copolymerized nylon, ultraviolet curing acrylic resin, fluorocarbon resins, and the like.

In addition to the above insulating materials, those in which a charge transporting substance is enclosed may also be used. By enclosing a charge transporting substance, it is possible to obtain such effects as an improvement in charging properties of the particles by injection of an electric charge into the particles, and an improvement in stabilization of the amount of charges of the particles by releasing excessive amount of charges.

Examples of the charge transporting substance include hole transporting substances such as hydrazone compounds, stilbene compounds, pyrazoline compounds, and aryl amine compounds; electron transporting substances such as fluorenone compounds, diphenoquinone derivatives, pyran compounds, and zinc oxide; and self-supporting resins having charge transporting properties.

Specific examples thereof include polyvinyl carbazole, and polycarbonate obtained by polymerization of a specific dihydroxy aryl amine and bischloroformate as described in U.S. Pat. No. 4,806,443. Because the dielectric film may affect the charging characteristics and flowability of the particles, the material should be properly selected in consideration of the composition and other properties of the particles. The display substrate, which is one of the pair of substrates and should transmit light, is preferably made of a transparent material that can be selected from the above materials.

The space member 24 that maintains a space between the display substrate 20 and the rear substrate 22 is formed in such a manner not to impair the transparency of the display substrate 20, and may be formed from a thermoplastic resin, a thermosetting resin, an electron radiation curing resin, a light curing resin, a rubber, a metal, or the like.

The space member 24 may be in the form of either cells or particles. Examples of those of cell-form include nets. Since nets are readily available and have a relatively uniform thickness, they are useful for producing the image display medium 12 at low cost. However, nets are not suitable for displaying a fine image, and are preferably used in a large-size image display device for which a high level of resolution is not required. Examples of the spacers having other cell forms include a sheet perforated in a matrix form by etching, laser processing or the like. Such a sheet is easier than a net in controlling the thickness, hole shape, hole size and the like. Therefore, use of a sheet in an image display medium that displays a fine image is effective in further improving the contrast.

The space member 24 may be integrated with either one of the display substrate 20 and the rear substrate 22. The supporting substrate 38, the supporting substrate 44, and the space member 24 having a cell pattern with a desired size may be produced by subjecting the substrates to etching or laser processing, or by conducting pressing, printing or the like by use of a pre-fabricated mold.

In this case, the space member 24 may be provided on either one of the display substrate 20 and the rear substrate 22, or both of them.

The space member 24 may be colored or colorless, but is preferably colorless and transparent in order not to adversely affect the image displayed on the image display medium 12. In that case, for example, a transparent resin such as polystyrene, polyester, acrylic resin or the like can be used as the material.

The space member 24 in the form of particles is preferably transparent, and examples thereof include particles of transparent resins such as polystyrene, polyester and acrylic resins, as well as glass particles. In this embodiment, being transparent refers to a property of a material to transmit 75% or more of light in the visible range.

The dispersion medium 50 used in the image display medium 12 of the invention disperses plural kinds of particles 34 having different colors and different absolute values of voltage that is required for the particles to move between the display substrate 20 and the rear substrate 22 (hereinafter may be referred to as a voltage for movement).

The voltage for movement can be determined as a value obtained by subtracting the amount of a force to bind the particles 34 to be in a state before an electrostatic force acts on the particles 34 (hereinafter referred to as a binding force) from the amount of the electrostatic force acting on the particles 34.

Namely, even when an electric filed is applied between the substrates, the particles 34 do not move if the binding force acting on the particle 34 is stronger than the electrostatic force acting on the particles 34. Particles 34 start moving when the electrostatic force acting on the particle 34 becomes stronger than the binding force acting on the particles 34.

As described above, in the dispersion medium 50, plural kinds of particles 34 having different absolute values of voltage for movement are dispersed. By controlling the electrostatic force and binding force that act on the particles 34 of each kind, it is possible to impart different kinds of particles 34 with different absolute values of voltage for movement.

The electrostatic force that acts on the particle 34 is determined by an average charge amount per particle of each particle that constitutes the group of particles 34.

Moreover, the binding force of the particles 34 is determined by the factors such as an amount of magnetic force of the particles 34, resistance at the interface of a particle and the dispersion medium 50, a volume average primary particle diameter of a particle, an average shape factor (an average value of shape factors SF1) of a particle, and the like.

In this embodiment, in order to control that the particles 34 is comprised of plural kinds of particles having different absolute values of voltage for movement, two predetermined values for the intensity of binding force and two predetermined values for the intensity of electrostatic force are prepared and, by controlling the combination of these values, the particles 34 of plural kinds having different values of voltage for movement are dispersed in the dispersion medium 50.

Namely, the particles 34 included in the same cell have either one of a first binding force of a predetermined intensity or a second binding force that is different from the first binding force, and have either one of a first electrostatic force of a predetermined intensity or a second electrostatic force that is different from the first electrostatic force. Further, different kinds of the particles 34 have different intensity of binding forces from each other. and/or different intensity of electrostatic forces from each other.

As described above, by preparing two different intensities of electrostatic force and two different intensities of binding force and appropriately combining these, the particles 34 are eventually regulated to include plural kinds of these having different absolute values of voltage for movement from each other and, therefore, the particles 34 comprised of particles having different absolute values of voltage for movement can be readily prepared in a simple structure.

Examples of the material for the particles 34 comprised of different kinds having different absolute values of voltage for movement include glass beads, particles of insulating metal oxides such as alumina and titania, particles of thermoplastic or thermosetting resins, particles of those resin having a colorant attached onto the surface, particles of thermoplastic or thermosetting resin containing an insulating colorant, and metal colloid particles having a color developing function by plasmon resonance.

Examples of the thermoplastic resin used for producing the particles include homopolymers or copolymers of styrenes such as styrene and chlorostyrene, monoolefins such as ethylene, propylene, butylene, and isoprene, vinyl esters such as vinyl acetate, vinyl propionate, vinyl benzoate, and vinyl butyrate, o-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate, vinyl ethers such as vinyl methyl ether, vinyl ethyl ether, and vinyl butyl ether, and vinyl ketones such as vinyl methyl ketone, vinyl hexyl ketone, and vinyl isopropenyl ketone.

Examples of the thermosetting resin used for producing the particles include crosslinked copolymers mainly composed of divinyl benzene, crosslinked resins such as crosslinked polymethyl methacrylate, phenolic resin, urea resin, melamine resin, polyester resin, and silicone resin. Examples of the typical binding resin include polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, polypropylene, polyester, polyurethane, epoxy resin, silicone resin, polyamide, denatured rosin, and paraffin wax.

As the colorant, organic or inorganic pigments, and oil-soluble dyes can be mentioned, and examples thereof include known colorants such as magnetic powder such as magnetite and ferrite, carbon black, titanium oxide, magnesium oxide, zinc oxide, phthalocyanine copper-based cyan coloring materials, azo-based yellow coloring materials, azo-based magenta coloring materials, quinacridone-based magenta coloring materials, red coloring materials, green coloring materials, and blue coloring materials. Specific examples thereof include aniline blue, chalcoil blue, chromium yellow, ultramarine blue, Du Pont oil red, quinoline yellow, methylene blue chloride, phthalocyanine blue, malachite green oxalate, lamp black, rose bengal, C.I. pigment red 48:1, C.I. pigment red 122, C.I. pigment red 57:1, C.I. pigment yellow 97, C.I. pigment blue 15:1, and C.I. pigment blue 15:3.

Moreover, sponge-like particles and hollow particles having an air-contained porous structure can be used as white particles.

Charge controlling agents may be added to the resin particles, as necessary. As the charge controlling agent, known agents used for electrophotographic toner materials can be used, and examples thereof include cetylpyridyl chloride, quaternary ammonium salts such as trade names: BONTRON P-51, BONTRON P-53, BONTRON E-84, BONTRON E-81 (manufactured by Orient Chemical Industries, Ltd.), salicylic acid-based metal complexes, phenol-based condensates, tetraphenyl-based compounds, metal oxide particles, and metal oxide particles subjected to a surface treatment with various coupling agents.

Magnetic materials may be added to the inside or surface of the particles, as necessary. As the magnetic material, organic and inorganic magnetic materials, which may be coated with a colorant, can be used. Moreover, transparent magnetic materials, in particular transparent organic magnetic materials are more preferable because they do not inhibit color formation of colored pigments, and have a lower specific gravity than that of inorganic magnetic materials.

As the colored magnetic powder, for example, small-diameter colored magnetic powder as described in Japanese Patent Application Laid-Open (JP-A) No. 2003-131420 can be used. Those comprised of a magnetic particle and a colored layer formed thereon may be used. The colored layer may be appropriately selected and may be formed from a pigment or the like to impart the magnetic powder with an impermeable color and, for example, a light-interference thin film is preferably used. The light-interference thin film is a thin film of an achromatic material such as SiO2 and TiO2 having a thickness equivalent to the wavelength of light, which selectively reflects a specific wavelength of light by light interference occurring within the thin film.

An external additive may be added to the surface of the particles, as necessary. The color of the external additive is preferably transparent in order not to affect the color of the particles.

Examples of the external additive include inorganic particles of metal oxides such as silicon oxide (silica), titanium oxide, and alumina. In order to adjust the charging properties, flowability, environment-dependency and the like of the particles, these may be surface-treated with a coupling agent or silicone oil.

Examples of the coupling agent include those having positive charging properties, such as aminosilane-based coupling agents, aminotitanium-based coupling agents, and nitrile-based coupling agents, and those having negative charging properties, such as nitrogen-free (composed of atoms other than nitrogen) silane-based coupling agents, titanium-based coupling agents, epoxy silane coupling agents, and acrylsilane coupling agents. Similarly, examples of the silicone oil include those having positive electrification nature, such as amino-denatured silicone oil, and those having negative charging properties, such as dimethyl silicone oil, alkyl-denatured silicone oils, α-methyl sulfone-denatured silicone oils, methylphenyl silicone oils, chlorophenyl silicone oils, and fluorine-denatured silicone oils. These may be selected depending on a desired resistance of the external additive.

Among these external additives, well-known hydrophobic silica and hydrophobic titanium oxide are preferred, and titanium compounds as described in JP-A No. 10-3177, which are obtained by the reaction between TiO(OH)₂ and a silane compound such as a silane coupling agent, are particularly preferred. As the silane compound, any one of chlorosilane, alkoxy silane, silazane, special silylated agents can be used. The titanium compounds are produced by reacting TiO(OH)₂ prepared by a wet process with a silane compound or silicone oil, and drying. Since these compounds do not undergo a sintering process performed at several hundred degrees, strong bonds between Ti molecules are not formed and no aggregation is caused, and the obtained particles are nearly primary particles. Moreover, since TiO(OH)₂ is directly reacted with a silane compound or silicone oil, the treatment amount of the silane compound or silicone oil can be increased and the charging characteristics can be controlled by adjusting the treatment amount of the silane compound or the like, and the amount of a charging ability that can be imparted can be significantly improved from that of conventional titanium oxide.

The volume average primary particle of the external additive is generally 5 to 100 nm, preferably 10 to 50 nm, but not limited thereto.

The mixing ratio of the external additive and the particles is appropriately adjusted in consideration of the particle size of the particles and the external additive. If the amount of the external additive is too much, part of the external additive may be liberated from the surface of particles of one group to adhere to the surface of particles of the other group, which may result in the failure to achieve desired charging characteristics. The amount of the external additive is usually 0.01 to 3 parts by weight, more preferably 0.05 to 1 part by weight with respect to 100 parts by weight of the particles.

The external additive may be added to only one of the plural kinds of particles, or may be added to two or more, or all of the plural kinds of the particles. When the external additive is added to the surface of all of the plural kinds of the particles, it is preferable that the external additive is strongly fixed to the particle surface by embedding the external additive into the particle surface by an impact force, or by heating the particle surface. In this way, the external additive can be prevented from liberating from the particles and strongly aggregating with the external additive having an opposite polarity to form an aggregate of the external additive which is difficult to dissociate in an electric field. Consequently, deterioration in image quality can be prevented.

As the method of preparing each group of the particles, any conventionally known methods may be used. For example, a method as described in JP-A No. 7-325434 can be used, in which a resin, a pigment, and a charge controlling agent are weighed to a predetermined mixing ratio, and the pigment is added to the resin after being heated to melt and mixed and dispersed. The dispersion is then cooled and ground into particles in a mill such as a jet mill, a hammer mill, and a turbo mill, and then the obtained particles are further dispersed in a dispersion medium. In another method, particles containing a charge controlling agent are prepared by a polymerization method such as suspension polymerization, emulsion polymerization, and dispersion polymerization, or other method such as coacervation, melt dispersion, and emulsion aggregation, and dispersed in a dispersion medium to obtain a particle dispersion liquid. Another method uses an appropriate device which is capable of dispersing and mixing a resin, a colorant, a charge controlling agent and materials of the dispersion medium at a temperature at which the resin is plasticizable, the dispersion medium does not boil, and lower than the decomposition point of a charge controlling agent and/or a colorant. Specifically, a pigment, a resin, and a charge controlling agent is mixed in a shooting star type mixer or a kneader, and heated to melt in a dispersion medium. The melt mixture is cooled with stirring, coagulated, and deposited to obtain particles utilizing the temperature dependency of the solvent solubility of the resin.

Moreover, there is another method in which the above-described raw materials are put in an appropriate vessel including granular media for dispersion and mixing, for example, an attritor or a heated vibration mill such as a heated ball mill, and dispersed and mixed in the vessel at a temperature preferably in a range of, for example, 80° C. to 160° C. As the granular media, steels such as stainless steel and carbon steel, alumina, zirconia, silica and the like are preferably used. In preparing the particles by this method, thoroughly mobilized raw materials are dispersed in the vessel with the granular media, and the dispersion medium is cooled to allow the resin containing the colorant to precipitate from the dispersion medium. The granular media generate a shearing motion and/or an impact motion by keeping moving during and even after cooling to decrease the particle size.

As the particles 34 used in the image display medium 12 of the invention, metal colloid particles having a color forming property due to plasmon resonance may be used as the particles that exhibit different color forming properties in a dispersed state.

The metal used for the metal colloid particles may be precious metals, copper or the like (hereinafter collectively referred to as “metals”). The precious metals are not particularly limited, and examples thereof include cold, silver, copper, ruthenium, rhodium, palladium, osmium, iridium, and platinum. Among these metals, gold, silver, copper, and platinum are preferred.

The metal colloid particles may be prepared by know methods such as those described in “Kilizoku Nanoryushino Gosei, Chosei, Control Gijutsuto Oyotenkai (Synthesis, Preparation, and Control Technique of Metal Nanoparticles and Development of Applications)” (Technical Information Institute Co., Ltd., 2004). The following are examples of these, but the invention is not limited thereto.

For example, the metal colloid particles may be prepared by chemical methods in which metal ions are reduced to metal atoms or metal clusters, and then formed into nanoparticles, or physical methods in which a bulk metal is evaporated in an inert gas and the atomized metal is trapped with a cold trap or the like, or a metal is vacuum-deposited on a polymer thin film to form a metal thin film, and then the film is heated to break, and then disperse the metal particles in a solid phase into a polymer. The chemical methods require no special apparatus and are advantageous for preparing the metal colloid particles of the invention. Examples thereof will be described later, but the methods are not limited thereto.

The metal colloid particles are formed from the compound of the above metals. The metal compound is not particularly limited as long as it contains the above-described metal, and examples thereof include chlorauric acid, silver nitrate, silver acetate, silver perchlorate, platinic chloride, platinum potassium, copper chloride (II), copper acetate (II), and copper sulfate (II).

The metal colloid particles can be obtained as a dispersion liquid of metal colloid particles prepared by dissolving the metal compound in a solvent, reducing, the compound into a metal, and protecting the metal with a dispersant. Alternatively, the metal colloid particles may also be obtained in the form of a solid sol by removing the solvent from the dispersion liquid. The metal colloid particles may be in either of these forms.

When the metal compound is dissolved, a polymer pigment dispersant, which will be described later, may be used. By using the polymer pigment dispersant, stable metal colloid particles protected by the dispersant are obtained. In this case, it is possible to control the concentration of the dispersant to be adsorbed to the surface of the metal colloid particles by using a polymer pigment dispersant of a desirable kind under desirable conditions (e.g., concentration and stirring time). More specifically, the amount of the polymer pigment dispersant adsorbed to the surface of the metal colloid particles can be increased by increasing the concentration of the polymer pigment dispersion or by increasing the time period for stirring the polymer pigment dispersant. These treatments make it possible to control the mobility of the metal colloid particles.

When the metal colloid particles in the invention are used, they may be used as a dispersion liquid of the metal colloid particles obtained as described above, or as a solid sol obtained by removing the solvent and re-dispersing the solid sol in another solvent. However, the present embodiment is not limited thereto.

When the metal colloid particles are used as a dispersion liquid, the solvent used in the aforementioned preparation is preferably an insulating liquid which will be described later. When the solid sol is used after undergoing re-dispersion, the solvent to prepare the solid sol may be any solvent is not particularly limited. The solvent used for the re-dispersion is preferably an insulating liquid which will be described later.

The metal colloid particles can form various colors depending on the kind, shape, volume average primary particle size and the like of the metal. By using the particles in which the kind, shape, and volume average primary particle size of the metal is controlled, various color phases including the RGB color formation can be obtained, thereby making the image display medium 12 to display a color image. Moreover, by controlling the shape and the particle size of the metal and resulting metal colloid particles, an RGB-type full color image display medium can be obtained.

The volume average primary particle size of the metal colloid particles that exhibit each of R, G, and B in the ROB system is not particularly specified because the color forming also depends on the preparation conditions, shape, particle size or the like of the metal or particles. However, for example, in the case of gold colloid particles, R, G, and B tend to be sequentially developed in this order as the volume average primary particle size increases.

As the method for measuring the volume average primary particle size in this embodiment, a laser diffraction scattering method can be applied, in which particles are irradiated with a laser beam, and the average particle size is calculated from the generated diffraction and the intensity distribution pattern of scattered light.

The content (% by weight) of the particles 34 with respect to the total weight of the content in the cell is not particularly limited as long as a desired color phase can be obtained. It is effective as the image display medium 12 to adjust the content of the cell by regulating the thickness of the cell. More specifically, the content of the particles may be decreased when the thickness of the cell is large, and may be increased when the thickness of the cell is small, and the content of the particles is usually 0.01 to 50% by weight.

In the image display medium 12 of the invention, insulating particles 36 are enclosed in each cell. The insulating particles 36 serve as a reflective member in the image display medium of the invention, and have a different reflective property from that of particles 34.

In the invention, the term having different reflective properties from those of particles 34 refers to that when the dispersion medium 50 dispersing only particles 34 and the dispersion medium 50 dispersing only insulating particles 36 are compared, differences in phase, brightness and saturation of color are visually observed between them.

In this embodiment, the insulating particles 36 are explained to be composed of plural particles having larger particle diameter than the particles 34, but the insulating particles 36 are not limited to be in a particle form but may be in a film form or a plate form, as long, as holes are provided therein through which the particles 34 can move and the reflective properties are different from those of the particles 34.

The insulating particles 36 are particles having an insulating property and a different color from that of the particles 34 which are enclosed in the same cell together with the insulating particles 36. The insulating particles 36 are arranged in a direction almost perpendicular to the direction in which the rear substrate 22 and the display substrate 20 face each other, with spaces through which the particles 34 can move. Further, spaces in which plural layers of the particles 34 can be formed in a direction along which the rear substrate 22 and the display substrate 20 face each other are provided between the insulating particles 36 and the rear substrate 22, and between the display substrate 20 and the insulating particle 36.

In this embodiment, being insulating means that the volume resistivity is 10¹⁰Ω·cm or more, and is preferably 10¹²Ω·cm or more.

Namely, the particles 34 can move from the side of rear substrate 22 to the side of display substrate 20, or from the side of display substrate 20 to the side of rear substrate 22, through the spaces provided among the insulating particles 36. The color of the insulating particle 36 is preferably, for example, white or black in order to serve as a background color. In this embodiment, the insulating particles 36 are explained to be white.

Examples of the insulating particles 36 include spherical particles of a benzoguanamine-formaldehyde condensate, spherical particles of a benzoguanamine-melamine-formaldehyde condensate, spherical particles of a melamine-formaldehyde condensate (trade name: Epostar, manufactured by Nippon Shokubai Co., Ltd.), spherical fine particles of crosslinked polymethyl methacrylate containing titanium oxide (trade name: MBX-White, manufactured by Sekisui Plastics Co., Ltd.), spherical fine particles of crosslinked polymethyl methacrylate (trade name: Chemisnow MX, manufactured by Sohken Kagaku), particles of polytetrafluoroethylene (trade name: Lubron L, manufactured by Daikin Industries, Ltd., trade name: SST-2, manufactured by Shamrock Technologies Inc.); particles of carbon fluoride (trade name: CF-100, manufactured by Nippon Carbon Co., Ltd., trade names: CFGL, CFGM, manufactured by Daikin Kogyo); silicone resin particles (trade name: Tosspearl, manufactured by Toshiba Silicone K. K.); polyester particles containing titanium oxide (trade name: Biryushea PL 1000 White T, manufactured by Nippon Paint Co., Ltd.); polyester-acrylic particles containing titanium oxide (trade name: Konac No. 1800 White, manufactured by NOF CORPORATION); spherical particles of silica (trade name: Hipresica, manufactured by UBE-NITTO KASEI Co., Ltd.) and the like.

The insulating particles are not limited to the above particles, but may be those obtained by dispersing a white pigment such as titanium oxide in a resin, grinding, and classifying into a desired particle size.

Since the insulating particles 36 are provided between the display substrate 20 and the rear substrate 22, the volume average primary particle size thereof should be in the range of from ⅕ to 1/50 of the distance between the display substrate 20 and the rear substrate 22, and the content of the insulating particles 36 should be in the range of from 1% to 50% by volume with respect to the total content of the cell.

The dispersion medium 50 is preferably an insulating liquid.

Specific examples of the insulating liquid include hexane, cyclohexane, toluene, xylene, decane, hexadecane, kerosene, paraffin, isoparaffin, mineral oil, olive oil, silicone oil, dichloroethylene, trichloroethylene, perchloroethylene, high purity kerosene, ethylene glycol, alcohols, ethers, esters, dimethylformamide, dimethyl acetamide, dimethyl sulfoxide, N-methylpyrrolidone, 2-pyrrolidone, N-methylformamide, acetonitrile, tetrahydrofuran, propylene carbonate, ethylene carbonate, benzine, diisopropyl naphthalene, olive oil, isopropanol, trichlorotrifluoroethane, tetrachloroethane, dibromotetrafluoroethane, and mixtures thereof.

Water (pure water) may also be favorably used as a dispersion medium by removing impurities to achieve the later-described volume resistance. The volume resistance is preferably 10³ Ωcm or more, more preferably 10⁷ Ωcm to 10¹⁹ Ωcm, and further preferably 10¹⁰ Ωcm to 10¹⁹ Ωcm. By achieving such a volume resistance, generation of bubbles caused by electrolysis of a liquid due to an electrode reaction can be more effectively reduced, and the electrophoresis characteristics of the particles are not impaired at every conduction, thereby achieving an excellent repeating stability of the insulating liquid.

As necessary, an acid, an alkali, a salt, a dispersion stabilizer, a stabilizer for preventing oxidation or absorption of ultraviolet rays, an antibacterial agent, a preservative or the like may be added to the insulating liquid, and the content thereof is preferably in a range with which the specific volume resistance value of the insulating liquid as described above can be obtained.

Moreover, an anionc surfactant, a cationc surfactant, an amphoteric surfactant, a nonionic surfactant, a fluorine-based surfactant, a silicone-based surfactant, a metallic soap, an alkyl phosphoric acid ester, a succinic acid imide or the like may be added to the insulating liquid as a charge controlling agent.

Examples thereof include ionic or nonionic surfactants, block or graft copolymers composed of lipophilic and hydrophilic moieties, compounds having a polymer chain backbone, such as cyclic, star-shaped, or dendritic polymers (dendrimers), and compounds selected from metal complexes of salicylic acid, metal complexes of catechol, metal-containing bisazo dyes, tetraphenyl borate derivatives, or the like.

Specific examples of the surfactant include nonionic surfactants such as polyoxyethylene nonylphenyl ether, polyoxyethylene octylphenyl ether, polyoxyethylene dodecylphenyl ether, polyoxyethylene alkyl ether, polyoxyethylene fatty acid ester, sorbitan fatty acid ester, polyoxyethylene sorbitan fatty acid ester, and fatty acid alkylol amide; anionic surfactants such as alkylbenzene sulfonate, alkylphenyl sulfonate, alkylnaphthalene sulfonate, higher fatty acid salts, sulfate ester salts of higher fatty acid esters, and sulfonic acids of higher fatty acid esters; and cationic surfactants such as primary to tertiary amine salts, and quaternary ammonium salts. The content of such charge controlling agent is preferably 0.01% by weight or more and 20% by weight or less, most preferably 0.05 to 10% by weight with respect to the palticle solid content. If the content is less than 0.01% by weight, satisfactory charge control effect may not be achieved, and if the content exceeds 20% by weight, conductivity of the dispersion medium may be excessively increased to impair the handleability of the dispersing medium.

The particles 34 enclosed in the image display medium 12 of the invention may also be dispersed in a polymer resin as a dispersion medium 50, in the image display medium 12. It is also preferable that the polymer resin is a polymer gel.

Examples of the polymer resin include polymer gels derived from natural polymers such as agarose, agaropectin, amylose, sodium alginate, propyleneglycol alginate ester, isolichenan, insulin, ethyl cellulose, ethylhydroxyethyl cellulose, curdlan, casein, carrageenan, carboxymethyl cellulose, carboxymethyl starch, callose, agar, chitin, chitosan, silk fibroin, Guar Gum, quince seed, crown gall polysaccharide, glycogen, glucomannan, keratan sulfate, keratin protein, collagen, cellulose acetate, gellan gum, schizophyllan, gelatin, ivory palm mannan, tunicin, dextran, dermatan sulfate, starch, tragacanth gum, nigeran, hyaluronic acid, hydroxyethyl cellulose, hydroxypropyl cellulose, pustulan, funoran, decomposed xyloglucan, pectin, porphyran, methyl cellulose, methyl starch, laminaran, lichenan, lenthinan, and locust bean gum; and almost all kinds of polymer gels of a synthetic polymer.

Other examples include polymers containing a functional croup such as alcohol, ketone, ether, ester, and amide in the repeating units, such as polyvinyl alcohol, poly(meth)acrylamide and derivatives thereof, polyvinyl pyrrolidone, polyethylene oxide and copolymers containing these polymers.

Among these, gelatin, polyvinyl alcohol, and poly(meth)acrylamide are preferably used from the viewpoints of production stability and electrophoresis characteristics.

These polymer resins are preferably used as a dispersion medium 50 in combination with the aforementioned insulating liquid.

The size of the cell in the image display medium 12 of the invention is usually from 10 μm to 1 mm. The cell size is in a close relationship with the resolution of the image display medium 12, and the smaller the cell is, the higher the resolution of the display medium will become.

In order to fix the display substrate 20 and the rear substrate 22 together, fixing units such as a combination of a bolt and a nut, a clamp, a clip, and a frame for fixing a substrate may be used. Moreover, fixing means such as use of an adhesive, heat fusion, ultrasonic bonding may also be used.

The image display medium 12 can be used for bulletin boards, circulars, electronic blackboards, advertisements, signboards, blinking markers, electronic paper, electronic newspaper, electronic books, and document sheets that can also be used for a copier or printer, on which storing or rewriting of images can be performed.

The image display medium 12 can display different colors by changing the value of a voltage applied between the display substrate 20 and the rear substrate 22.

The image display medium 12 of the invention can display colors corresponding to each pixel of the image data, in each cell corresponding to each pixel of the image display medium 12, by the movement of particles 34 of each kind in accordance with an electric field formed between the display substrate 20 and the rear substrate 22.

As described above, the particles 34 according to this exemplary embodiment have different absolute values of a voltage necessary for the particles to move, depending on the type or color of the particles.

Further, the range of the voltage necessary for the particles 34 of one color to move is preferably different from that of the particles 34 having a different color.

The “range of the volume for moving” refers to a range from a voltage at which one kind of the particles 34 start moving to a point less than a voltage other kinds of the particles 34 start moving, in which the voltage value is chanced in a continuous manner between the display substrate 20 and the rear substrate 22. Namely, by applying a voltage in each range of each kind of the particles 34, it is possible to selectively move a specific kind of the particles 34.

The voltage necessary for the particles to move refers to a value of the voltage applied to the substrate at which a state in which no change in a display density of the image display medium 12 occurs by the movement of each kind of particles 34 turns to a state in which a change occurs in the display density, when chancing the voltage value applied between the display substrate 20 and the rear substrate 22 in a continuous manner.

The “change in a display density” refers to a state of a boundary at which the amount of change in the density in the display substrate 20 turns from less than 0.01 to 0.01 or more, which chance can be measured by a densitometer (X-Rite 404A, manufactured by X-Rite) by applying a voltage to the surface electrode 40 and the rear electrode 46 of the image display medium 12 and by decreasing or increasing the value of this voltage from 0 V.

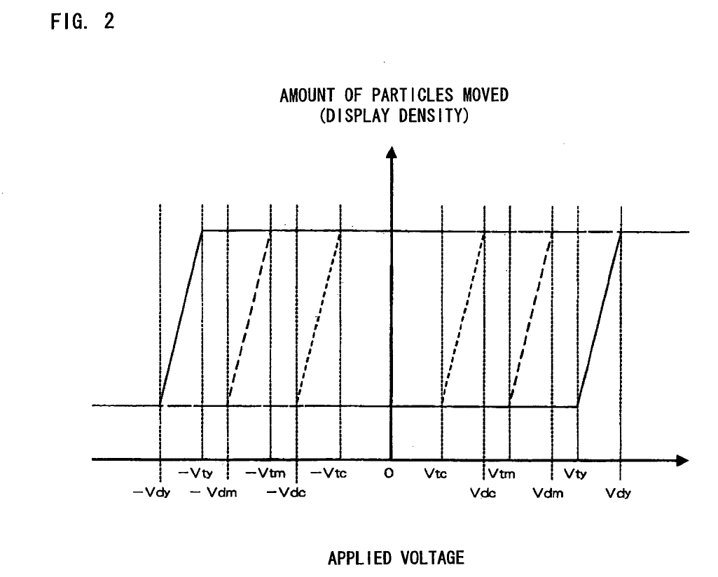

Next, the relationship between the intensity of an electric field and a change in display density due to the movement of the particles of each color between the substrates in the case of the plural kinds of particles 34 used in the image display medium 12 in this exemplary embodiment will be explained in detail with reference to FIG. 2.

In this exemplary embodiment, as shown in FIG. 1, magenta particles 34M with a magenta color, cyan particles 34C with a cyan color, and yellow particles 34Y with a yellow color are enclosed as the particles 34 in the same cell of the image display medium 12.

In the following, explanation will be given on the condition that absolute values of the voltage values represented by Vtc, −Vtc, Vdc, −Vdc, Vtm, −Vtm, Vdm, −Vdm, Vty, −Vty, Vdy, and −Vdy satisfy the relationship of |Vtc|<|Vdc|<|Vtm|<|Vdm|<|Vty|<|Vdy|.

Further, as shown in FIG. 1, absolute values of the voltage at which magenta particles 34M, cyan particles 34C and yellow particles 34Y start to move are expressed by |Vtm|, |Vtc| and |Vty|, respectively. Absolute values of saturation voltage, at which a change in display density stops to occur even when the voltage and the application time thereof applied between the substrate are increased from the initiation of the movement of the particles 34 of each color, i.e., the display density is saturated, of magenta particles 34M, cyan particles 34C and yellow particles 34Y are expressed by |Vdm|, |Vdc| and |Vdy|, respectively.

When a voltage is applied between the display substrate 20 and the rear substrate 22 and is gradually increased from 0 V to exceed +Vtc, a change in display density starts to occur due to the movement of the cyan particles 34C in the image display medium 12. When the voltage applied between the substrates is further increased to exceed +Vdc, the change in display density due to the movement of the cyan particles 34C in the image display medium 12 stops.

When the voltage applied between the display substrate 20 and the rear substrate 22 is further increased to exceed +Vtm, a change in display density starts to occur due to the movement of the magenta particles 34M in the image display medium 12. When the voltage is further increased to exceed +Vdm, the change in display density due to the movement of the magenta particles 34M in the image display medium 12 stops.

When the voltage applied between the substrates is further increased to exceed +Vty, a change in display density starts to occur due to the movement of the yellow particles 34Y in the image display medium 12. When the voltage is further increased to exceed +Vdy, the change in display density due to the movement of the yellow particles 34Y in the image display medium 12 stops.

On the other hand, when a negative-electrode voltage is applied from 0 V between the display substrate 20 and the rear substrate 22 and gradually increased to exceed the absolute value of −Vtc, a change in display density starts to occur due to the movement of the cyan particles 34C between the substrates in the image display medium 12. When the absolute value of the voltage level is further increased to exceed the absolute value of −Vdc, the change in display density due to the movement of the cyan particles 34C in the image display medium 12 stops.

When the absolute volume of the applied negative-elctrode voltage is further increased to exceed the absolute value of −Vtm, a change in display density starts to occur due to the movement of the magenta particles 34M in the image display medium 12. When the absolute value of the voltage is further increased to exceed the absolute value of −Vdm, the change in display density due to the movement of the magenta particles 34M in the image display medium 12 stops.

When the absolute value of the applied negative-electrode voltage is further increased to exceed the absolute value of −Vty, a change in display density starts to occur due to the movement of the yellow particles 34Y in the image display medium 12. When the absolute value of the voltage is further increased to exceed the absolute value of −Vdy, the change in display density due to the movement of the yellow particles 34Y in the image display medium 12 stops.

Namely, in this exemplary embodiment, as shown in FIG. 2, when a voltage at which a potential difference is in a range of from −Vtc to +Vtc (|Vtc| or less) is applied between the display substrate 20 and the rear substrate 22, no movement of the particles 34 (cyan particles 34C, magenta particles 34M, and yellow particles 34Y) that can cause a change in display density of the image display medium 12 occurs. When a voltage with an absolute value not less than the absolute values of +Vtc and −Vtc is applied between the substrates, movement of only the cyan particles 34C among the particles 34 of three colors that can cause a change in display density of the image display medium 12 occurs. When a voltage with an absolute value of not less than the absolute values of +Vdc and −Vdc is further applied between the substrates, the change in display density due to the movement of the cyan particles 34C per unit voltage stops.

When a voltage of not less than the absolute values of −Vtm and +Vtm and less than the absolute values of −Vdm and +Vdm is applied between the display substrate 20 and the rear substrate 22, movement of the magenta particles 34M among the particles 34 of three colors that can cause a change in display density of the image display medium 12 occurs. When a voltage with an absolute value of not less than the absolute values of −Vdm and +Vdm is applied between the substrates, the change in display density due to the movement of the magenta particles 34M per unit voltage stops.

When a voltage of not less than the absolute values of −Vty and +Vty is applied between the display substrate 20 and the rear substrate 22, movement of the yellow particles 34Y among the particles 34 of three colors that can cause a change in display density of the image display medium 12 occurs. When a voltage with an absolute value of not less than the absolute values of −Vdy and +Vdy is applied between the substrates, the change in display density due to the movement of the yellow particles 34Y per unit voltage stops.

As described above, it is preferable that the particles of respective colors of the particles 34 dispersed in the dispersion medium 50 of the image display medium 12 of the invention move between the substrates upon application of a voltage of different absolute values, and that the ranges of the voltages necessary for the particles of respective colors to move are different from each other.

The voltage that causes movement of the particles of respective colors is determined by an electrostatic force and a binding force that affect the particles, as discussed above, and the larger the absolute value of a value obtained by subtracting the value of the binding force from the value of the electrostatic force is, the larger the absolute value of the voltage that causes movement of the particles 34 becomes, and the smaller the absolute value of a value obtained by subtracting the value of the binding force from the value of the electrostatic force is, the smaller the absolute value of the voltage that causes movement of the particles 34 becomes.

In this exemplary embodiment, as discussed above, two different values of an intensity of the binding force and two different values of an intensity of the electrostatic force are prepared in advance, and by combining these values, the particles 34 of plural kinds having different voltages for moving are regulated to be dispersed in the dispersion medium 50. In the following, explanation of the electrostatic force and the binding force will be given.

Regarding the binding force, when the particles 34 of plural kinds are adhering to either of the display substrate 20 or the rear substrate 22, an adhesion force to make the particles adhere to the display substrate 20 or the rear substrate 22 is acting between the substrate and the particles 34. This adhesion force is known as a van der Waals force that is intrinsic to a substance and is generated upon a physical contact. This force is determined depending on the contact area of the particles to the substrate and the distance between the particles and the substrate. As the contact area increases, or as the distance decreases, the van der Waals force becomes larger. The contact area and the distance are determined depending on the particle size (volume average primary particle size) and the shape factor of the particles. The van der Waals force also depends on the material of the particles and the substrate surface.

When the particles are magnetized, a magnetic force is generated between the particles that are present in the vicinity of the display substrate 20 or the rear substrate 22 and the display substrate 20 or the rear substrate 22. Consequently, the binding force is under the influence of an average amount of magnetic charge, a volume average primary particle size, and an average shape factor (average value of shape factor SF1).

Further, since the particles 34 of plural kinds are dispersed in the dispersion medium 50, a resistance is generated at the interface of the surface of each particle and the dispersion medium 50 upon application of an electric field between the display substrate 20 and the rear substrate 22 to move the particles. It is presumed that this resistance is generated due to formation of a loose correlation (network, association) between the particles that are accumulated on or in the vicinity of the substrate surface. This resistance becomes largest at the time when the particles initiate moving, which gradually decreases as the particles move. For example, the particles 34 of respective colors that are accumulated on the rear substrate 22 form a weak network in the dispersion medium 50 and, from a microscopic viewpoint, increase the viscosity of an area around the particles 34, which generates a resistance when the particles initiate moving.

Hereinafter, the maximum value of the resistance generated at the interface between the dispersion medium 50 and each particle of the particles 34 (the resistance value at the initiation of movement) may be referred to as “a flow resistance”. It is presumed that this flow resistance also contributes to the binding force.

Therefore, in this exemplary embodiment, two values of average charge amount are determined as an intensity of electrostatic force in advance, and two values of any one of average magnetic charge, volume average primary particle size, average shape factor (average value of shape factor SF1) and flow resistance are also determined as an intensity of binding force in advance. Then, plural kinds of particles each showing either one of the above two kinds of intensity of binding force and either one of the above two kinds of intensity of electrostatic force are prepared. In this way, the particles 34 composed of plural kinds of particles having different absolute values of voltage for moving can be readily obtained.

The flow resistance of the surface of each particle to the dispersion medium 50 may be regulated by an appropriate adjustment of the type or amount of a substance added to the particle surface or in the vicinity of the particle surface. The flow resistance may also be regulated by an appropriate adjustment of the number of vibration of the particles vibrated which is provided by the display substrate 20 or the rear substrate 22.

The flow resistance of the particles 34 may be regulated, specifically, by modifying the surface of the particles 34 with a compound containing a long-chain alkyl group. The flow resistance may be regulated by changing the carbon number of the long-chain alkyl group or the amount of the surface modification with the compound containing a long-chain alkyl group.

Specific examples of the compound containing a long-chain alkyl group include paraffins such as triacontane, octacosane, heptacosane, hexacosane, tetracosane, docosane, heneicosane, and eicosane, alkoxysilanes such as octadecyltriethoxysilane, diethoxymethyloctadecylsilane, dodecyltriethoxysilane, octyltriethoxysilane, decyltrimethoxysilane, and hexyltriethoxysilane, chlorosilanes such as docosylmethyldichlorosilane, docosyltrichlorosilane, dimethyloctadecylchlorosilane, methyloctadecyldichlorosilane, octadecyltrichlorosilane, tetradecyltrichlorosilane, dodecyltrichlorosilane, and decyltrichlorosilane, and silazanes such as hexamethyldisilazane. In cases where the dispersion medium is silicone oil, it is preferable to use octadecyltriethoxysilane, diethoxymethyloctadecylsilane, dodecyltriethoxysilane, or decyltrimethoxysilane, from the viewpoint of readily forming a network including the silicone oil.

Alternatively, the flow resistance of the surface of the particles to the dispersion medium 50 may be controlled by coating the surface of the particles with a low molecular-weight gelling agent in the dispersion medium 50, by changing the coating amount or type of the low molecular-weight gelling agent for each kind of particles of the particles 34. According to this method, the flow resistance due to a network (association) formed by the low molecular-weight gelling agent on the surface of the particles of each kind of the particles 34 can be individually regulated.

Specific examples of the low molecular-weight gelling agent include dibenzylidene-D-sorbitol, 12-hydroxystearic acid, N-lauroyl-L-glutamic acid-α,γ-bis-N-butylamide, spin-labeled steroid, cholesterol derivatives, aluminum dialkylphosphate, L-isoleucine derivatives, L-valine derivatives, L-lysine derivatives, cyclic dipeptide derivatives, cyclohexane diamine derivatives, dibenzoyl urea derivatives, fluorine-containing diester compounds, long-chain alkyl-modified silicone, and carboxylate polyvalent metal salt-modified organosiloxane. Among these, when silicon oil is used as the dispersion medium, L-isoleucine derivatives and L-valine derivatives are preferable, since they readily form a network including the silicone oil.

The flow resistance can be determined by measuring a voltage at which the particles start to move, which voltage is formed by applying an electric field after applying an electric field between the display substrate 20 and the rear substrate 22 to accumulate the particles, for example, on and near the surface of the rear substrate 22, to the opposing display substrate. The measurement is conducted under conditions that the adhesion force between the particles and the rear substrate 22 is small.

The “small adhesion force” specifically means that the substrate surface has a low surface energy.

The average quantity of magnetism of each particle can be adjusted by, specifically, various methods used for magnetizing particles.

For example, as with the conventional electrophotographic magnetic toner, the particles may be produced by mixing a magnetic substance such as powder magnetite with a resin, or by dispersing and polymerizing a magnetic substance and a monomer. Alternatively, the particles may be produced by depositing a magnetic substance into fine pores of hollow particles. A method is also known in which particles are coated with a magnetic substance. For example, particles composed of a magnetic substance coated with a resin may be produced by initiating polymerization from active points provided on the surface of the magnetic substance, or by depositing a melted resin onto the surface of a magnetic substance. Organic magnetic substances that are lightweight, transparent or colored may also be used as the magnetic substance. The average quantity of magnetism of the particles can be regulated by an appropriate adjustment of the kind or amount of the magnetic substance to be used. Gold nanofine particles coated with a polymer (polyallyl amine hydrochloride), which is known to have ferromagnetism, may also be used.

In order to regulate the magnetic force that acts on the particles, the display substrate and the rear substrate may be slightly magnetized so that the particles having the aforementioned magnetic charge, i.e., magnetized, are magnetically attracted thereto. The display substrate is preferably composed of a transparent magnetic film that does not impair the transparency of the substrate. Examples of known transparent magnetic films include a cobalt-added titanium dioxide thin film, an iron-substituted titanium oxide nanosheet, and a magnetic thin film of a prussian blue analog. Other examples include, though having no transparency, flexible magnet thin films such as a highly flexible sheet magnet in which a rare earth magnetic substance is compounded, and a monomolecular magnetic sheet.

The size of the particles is regulated, specifically, in a process of producing the particles. When the particles are prepared by polymerization, the particle size can be adjusted by an appropriate adjustment of the amount of a dispersant or the like, dispersion conditions, heating conditions, or the like, and when the particles are prepared through the steps of mixing, grinding and classification, the particle size can be adjusted by an appropriate adjustment of the classification conditions or the like. When the constituent material of the particles are prepared by pulverizing with a ball mill, the particle size may be regulated by an appropriate adjustment of the size of steel balls used in the ball mill, rotation time, rotation speed and other conditions. The method of regulating the particle size is not limited to those described above.

The shape factor of the particles is, specifically, for example, preferably adjusted by a method described in JP-A No. 10-10775, where so-called suspension polymerization, in which a polymer is dissolved in a solvent, mixed with a colorant, and dispersed in an aqueous medium in the presence of an inorganic dispersant to obtain particles, is carried by adding an organic solvent having compatibility with a monomer (having no compatibility or little compatibility with a solvent), conducting suspension-polymerization to obtain particles, and then taking out and drying the particles while removing the organic solvent by an appropriately selected drying method. As the drying method, a freeze dry method is preferably mentioned, in which method freeze drying is preferably carried out at a temperature of from −10 to −200° C. (more preferably from −30° C. to −180° C.). The freeze drying is typically carried out at a pressure of about 40 Pa or less, and is most preferably carried out at 13 Pa or less. The particles shape may also be controlled by the method described in JP-A No. 2000-292971, in which small particles are aggregated, coalesced and grown to have a desired particle size.

Since the particles 34 move in the dispersion medium 50, it is also necessary to regulate the viscosity of the dispersion medium 50. When the viscosity of the dispersion medium 50 is equal to or above the predetermined value, contribution of the viscous resistance of the dispersion medium becomes too large relative to the movement of the particles, thereby failing to establish the range of potential difference for the movement of the particles at a desired electric field.

The viscosity of the dispersion medium 50 needs to be from 0.1 mPa·s to 20 mPa·s at a temperature of 20° C. from the viewpoint of moving velocity of the particles, namely a display speed, and is preferably from 0.5 mPa·s to 5 mPa·s, more preferably from 0.7 mPa·s to 2 mPa·s.

When the viscosity of the dispersion medium 50 is in the range of from 0.1 mPa·s to 20 mPa·s, variation in the adhesion force between the particles 34 dispersed in the dispersion medium 50 and the display substrate 20 or the rear substrate 22, the flow resistance, and the electrophoresis time can be reduced.

The viscosity of the dispersion medium 50 can be regulated by appropriately adjusting the molecular weight, structure, composition, and the like of the dispersion medium. Measurement of the viscosity may be conducted by using a viscometer (trade name: B-8L, manufactured by Tokyo Keiki Co., Ltd.).

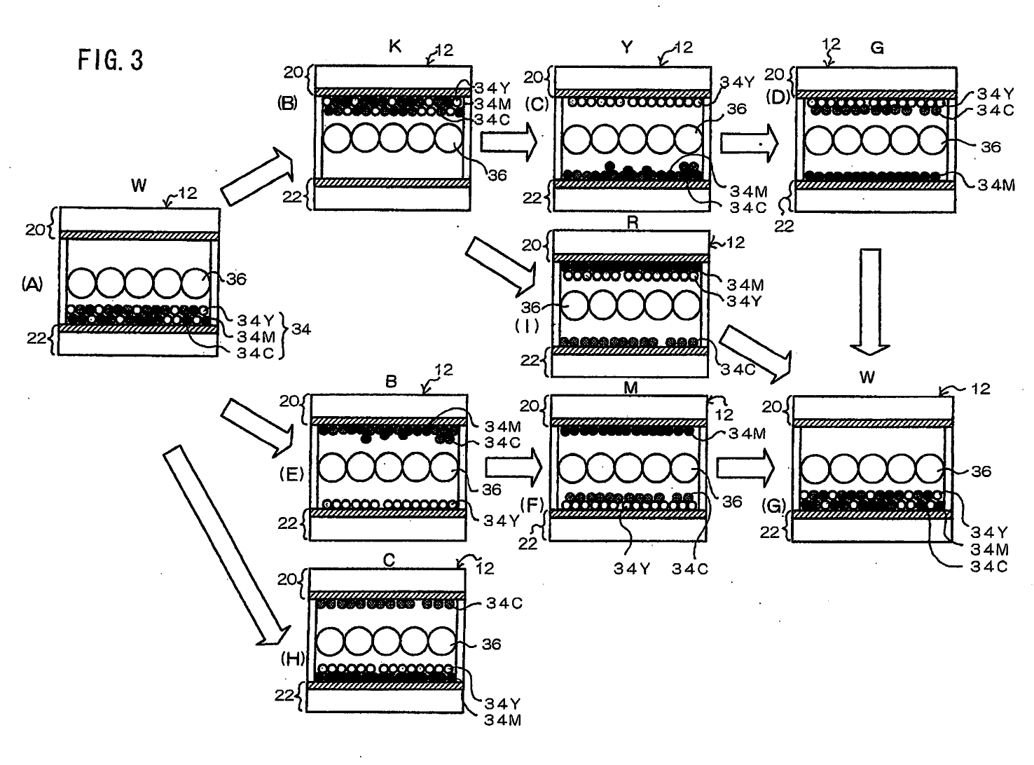

Next, the mechanism of the particle movement when an image is displayed on the image display medium 12 of the invention will be explained with reference to FIG. 3.

In FIG. 3, yellow particles 34Y, magenta particles 34M and cyan particles 34C as described with reference to FIG. 2 are enclosed in the image display medium 12 as the particles of plural kinds that initiate moving at different intensities of electric field.

In the following, explanation will be given on the condition that the absolute value of the voltage for moving of magenta particles 34M is greater than the absolute value of the voltage for moving of the cyan particles 34C, and that that the absolute value of the voltage for moving of yellow particles 34Y is greater than the absolute value of the voltage for moving of the magenta particles 34M, as discussed in reference with FIG. 2. Hereinafter, the voltage that is equal to or greater than the absolute value of the voltage for moving of the cyan particles 34C and less than the absolute value of the voltage for moving of the magenta particles 34M is referred to as a “first voltage”, the voltage that is equal to or greater than the absolute value of the voltage for moving of the magenta particles 34M and less than the absolute value of the voltage for moving of the yellow particles 34Y is referred to as a “second voltage”, and the voltage that is equal to or greater than the absolute value of the voltage for moving of the yellow particles 34Y is referred to as a “third voltage”.

Namely, as will be discussed later, when the first voltage is applied between the display substrate 20 and the rear substrate 22, the cyan particles 34C whose voltage for moving is not greater than the second voltage move between the substrates. When the second voltage is applied between the display substrate 20 and the rear substrate 22, the cyan and magenta particles 34C and 34M whose voltages for moving are not greater than the third voltage move between the substrates. When the third voltage is applied between the display substrate 20 and the rear substrate 22, the cyan, magenta and yellow particles 34C, 34M and 34Y whose voltages for moving are not greater than the third voltage move between the substrates.

When a voltage is applied to the display substrate 20 that is higher than a voltage applied to the rear substrate 22 to give a potential difference between the substrates, the electric field intensities are referred to as “+ first voltage”, “+ second voltage” and “+ third voltage”, respectively. On the other hand, when a voltage is applied to the rear substrate 22 that is higher than a voltage applied to the display substrate 20 to give a potential difference between the substrates, the electric field intensities are referred to as “−first voltage”, “−second voltage” and “−third voltage”, respectively.

As shown in a drawing marked with (A) in FIG. 3, if all of the magenta particles 34M, cyan particles 34C and yellow particles 34Y are positioned on the side of the rear substrate 22 in an initial state, when a “+third voltage” is applied between the display substrate 20 and the rear substrate 22, all of the magenta particles 34M, the cyan particles 34C, and the yellow particles 34Y move to the side of the display substrate 20. In this state, even if the electric field is made to zero, each group of the particles does not move from the display substrate 20, thereby displaying a black color that is a subtractive color mixture formed by magenta, cyan and yellow (see a drawing marked with (B)).

Next, when a “−second voltage” is applied between the display substrate 20 and the rear substrate 22 from the state of (B), the magenta particles 34M and the cyan particles 34C move to the rear substrate 22, thereby displaying a yellow color of the yellow particles 34Y remaining on the side of the display substrate 20 (see a drawing marked with (C)).

Further, when a “+first voltage” is applied between the display substrate 20 and the rear substrate 22 from the state of (C), the cyan particles 34C that have moved to the side of the rear substrate 22 moves back to the side of the display substrate 20. Accordingly, a green color is displayed that is a subtractive color mixture of the yellow and cyan particles positioned on the side of the display substrate 20 (see a drawing marked with (D)).

When a “−first voltage” is applied between the display substrate 20 and the rear substrate 22 from the state of the aforementioned (B), the cyan particles 34C move to the side of the rear substrate 22. Accordingly, a red color is displayed that is a subtractive color mixture of the cyan and magenta particles positioned on the side of the display substrate 20 (see a drawing marked with (I)).

On the other hand, when a “+second voltage” is applied between the display substrate 20 and the rear substrate 22 from the initial state shown as (A), the magenta particles 34M and the cyan particle group 34C move to the side of the display substrate 20. Accordingly, a blue color is displayed that is a subtractive color mixture of the magenta and cyan particles positioned on the side of the display substrate 20 (see a drawing marked with (E)),

When a “−first voltage” is applied between the display substrate 20 and the rear substrate 22 from the state shown as (E), the cyan particles 34C positioned on the side of the display substrate 20 move to the side of the rear substrate 22. Accordingly, a magenta color of the magenta particles 34M remaining on the side of the display substrate 20 is displayed (see a drawing marked with (F)).

When a “−third voltage” is applied between the display substrate 20 and the rear substrate 22 from the state shown as (F), the magenta particles 34M positioned on the side of the display substrate 20 moves to the side of the rear substrate 22. Accordingly, a white color of the insulating particles 36 is displayed, since no particles are positioned on the side of the display substrate 20 (see a drawing marked with (C)).

When a “+first voltage” is applied between the display substrate 20 and the rear substrate 22 from the initial state shown as (A), the cyan particles 34C move to the side of the display substrate 20. Accordingly, a cyan color of the cyan particles 34C positioned on the side of the display substrate 20 is displayed (see a drawing marked with (H)).

Further, when a “−third voltage” is applied between the display substrate 20 and the rear substrate 22 from the state shown as (I), all of the cyan, magenta and yellow particles move to the side of the rear substrate 22, thereby displaying a white color (see a drawing marked with (G)).

In the same manner, when a “−third voltage” is applied between the display substrate 20 and the rear substrate 22 from the state shown as (D), all of the cyan, magenta and yellow particles move to the side of the rear substrate 22, thereby displaying a white color (see a drawing marked with (G)).

As described above, in the image display medium 12 of the invention, plural kinds of particles 34 having different colors and different voltages for moving are enclosed in the dispersion medium 50 between the display substrate 20 and the rear substrate 22, and particles of desired color can be selectively moved by applying a voltage of the corresponding intensity. Therefore, movement of particles of other colors than the desired color in the dispersion medium 50 can be suppressed, thereby reducing intermixing of undesired colors.

Moreover, as shown in FIG. 3, by dispersing the particles 34 of cyan, magenta and yellow in the dispersion medium 50, it is possible to display colors of cyan, magenta, yellow, blue, red, green and black, and also a white color of the insulating particles 36, thereby enabling display of desired colors.

The image display device according to this exemplary embodiment will be further described below.

As shown in FIG. 1, the image display device 10 according to this exemplary embodiment includes the image display medium 12 and a writing device 17.

The image display device 10 corresponds to the image display device of the invention, the image display medium 12 corresponds to the image display medium of the invention, and the writing device 17 corresponds to the writing device of the invention and the electric field forming unit of the image display device of the invention.

According to this exemplary embodiment, the image display medium 12 is fixed to the image display device 10. However, the image display medium 12 may also be detachably attached to the image display device 10. In this case, a state in which the image display medium 12 is connected to the writing device 17 such that a signal can be communicated can be regarded as a state in which the image display medium 12 is attached to the image display device 10, and a state in which the image display medium 12 is not electrically connected to the writing device 17 can be regarded as a state in which the image display medium is detached from the image display device 10. By employing such a structure, the image display medium 12 can be readily exchanged independent of the image display device 10 and the writing device 17.

The writing device 17 includes a voltage application unit 16, a control unit 18, a storage unit 14, and an acquisition unit 15. The voltage application unit 16, storage unit 14, and acquisition unit 15 are connected to the control unit 18 such that a signal can be communicated.

The voltage application unit 16 corresponds to the voltage application unit of the writing device of the invention, the control unit 18 corresponds to the control unit of the writing device of the invention, and the acquisition unit 15 corresponds to the acquisition unit of the writing device of the invention.

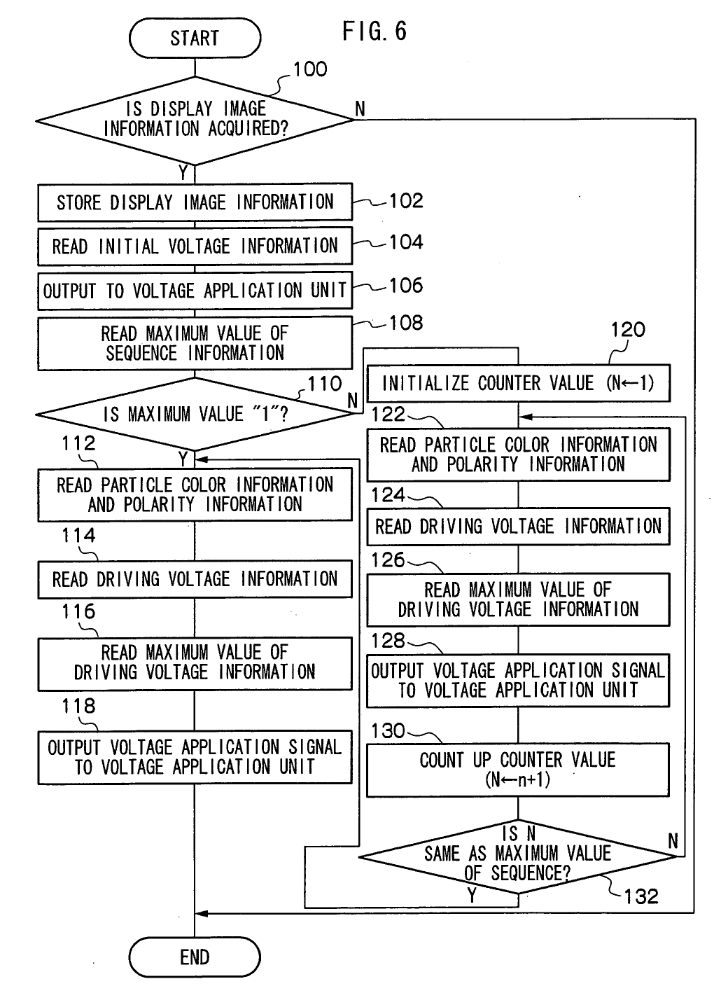

The control unit 18 is constructed as a microcomputer including a CPU (central processing unit) that controls operations of the whole device, an RAM (random access memory) that temporarily stores various kinds of data, and an ROM (read only memory) that stores a control program for controlling the whole device, and various programs including the later-described image displaying program illustrated by a processing routine shown in FIG. 6. The image displaying program may be stored in the ROM in advance, or may be stored in the storage unit 14.

The voltage applying unit 16 is electrically connected to the surface electrode 40 and the rear electrode 46. In this exemplary embodiment, both the surface electrode 40 and the rear electrode 46 are electrically connected to the voltage applying unit 16. However, it is also possible that either one of the surface electrode 40 and the rear electrode 46 is grounded and the other one is connected to the voltage applying unit 16.

The voltage application unit 16 is a voltage application device that applies a voltage to the surface electrode 40 and the rear electrode 46, which applies a voltage controlled by the control unit 18 between the surface electrode 40 and the rear electrode 46.

The acquisition unit 15 obtains display image information including display color information regarding the color of an image to be displayed on the image display medium 12 (hereinafter may be referred to as display color) from the outside the writing device 17.

The above-mentioned image color and display color correspond to a color phase.

Examples of the acquisition unit 15 include a connection port to be connected to a wired communication network or a wireless communication network. The acquisition unit 15 may be an operation panel that receives operating instructions from the operator. In this case, the acquisition unit 15 obtains display image information by the operating instructions given by the operator concerning the display image information to the acquisition unit 15 serving as an operation panel.

The storage unit 14 originally stores tables such as a correspondence table 14A and a correspondence table 14B, initial voltage information, voltage application time information and various data, and also newly stores various data.

The initial voltage information includes, as an initial operation prior to displaying an image on the image display medium 12, voltage level information concerning the voltage to be applied between the display substrate 20 and the rear substrate 22 to display a black or white color, polarity information indicating the polarity of the voltage, and voltage application time information indicating the voltage application time.

The voltage application time information indicates a period of time for voltage application to the space between the substrates of the image display medium 12 to display a chromatic color. In this exemplary embodiment, the voltage application time is constant, but it may also be variable.

In this exemplary embodiment, the voltage of the initial voltage information is determined as a voltage value that exceeds the absolute value of the maximum voltage for moving among the particles 34, in order that all of the particles 34 are moved to the side of the rear substrate 22.

The polarity information is either one of positive electrode information that indicates a positive electrode, or negative electrode information that indicates a negative electrode. In this exemplary embodiment, when the polarity information is positive electrode information, it indicates that the surface electrode 40 is a positive electrode and the rear electrode 46 is a negative electrode. On the other hand, when the polarity information is negative electrode information, it indicates that the surface electrode 40 is a negative electrode and the rear electrode 46 is a positive electrode. The setting may be in an opposite manner.

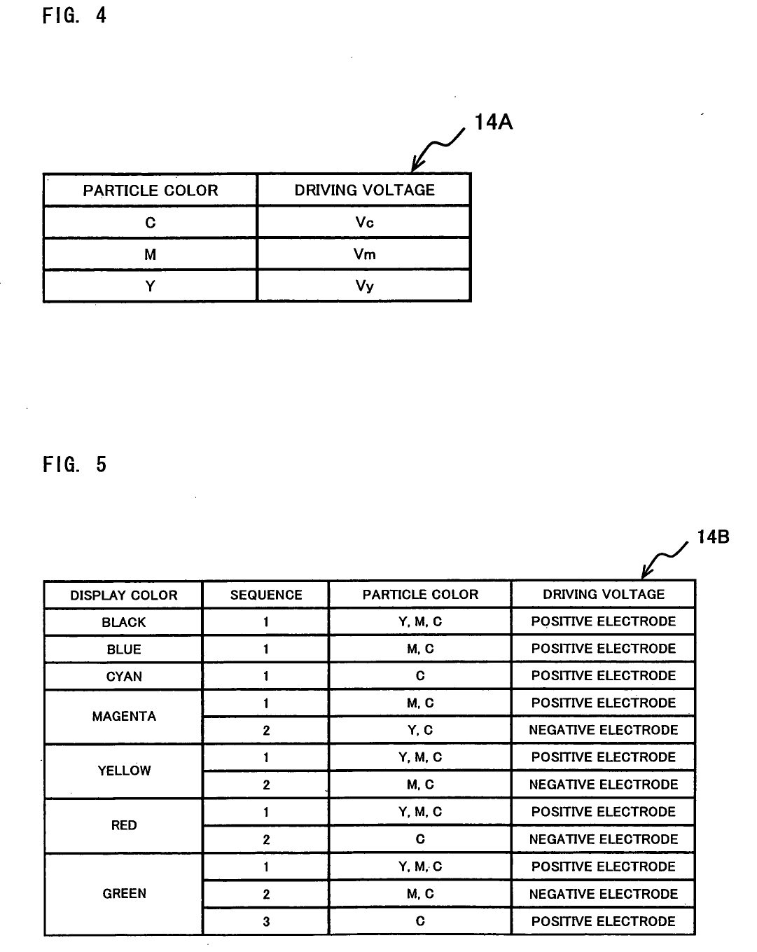

The correspondence table 14A is, as shown in FIG. 4, a region that stores information regarding particle type for distinguishing the particles 34 of different colors from each other, and stores information of the particle color and the driving voltage in order to correlate with each other.

The above-described driving voltage information corresponds to the information that indicates a value of a voltage to be applied between the substrates in order to move the particles 34 of each color, and different values of predetermined voltages corresponding to each color is stored so as to correlate with the particle color information indicating the corresponding color particles of the particles 34.

In this exemplary embodiment, as illustrated in FIG. 2, the storage unit 14 originally stores a driving voltage for the cyan particles 34C (Vc) as a value that is equal to or greater than the absolute value of the voltage for moving of the cyan particles 34C (|Vtc|) and less than the absolute value of the voltage for moving of the magenta particles 34M (|Vtm|), whose voltage for moving is larger than that of the cyan particles 34C (namely, a voltage within a range in which the cyan particles 34C move).

In a similar manner, as illustrated in FIG. 2, the storage unit 14 originally stores a driving voltage for the magenta particles 34M (Vm) as a value that is equal to or greater than the absolute value of the voltage for moving of the magenta particles 34M (|Vtm|) and less than the absolute value of the voltage for moving of the yellow particles 34Y (|Vty|), whose voltage for moving is larger than that of the magenta particles 34M (namely, a voltage within a range in which the magenta particles 34M move).

In a similar manner, as illustrated in FIG. 2, the storage unit 14 originally stores a driving voltage for the yellow particles 34Y (Vy) as a value that is equal to or greater than the absolute value of the voltage for moving of the yellow particles 34Y (|Vty|) (namely, a voltage range in which the yellow particles 34Y move).

Consequently, the absolute values of driving voltages for the particles 34 of each color are originally adjusted in the order of the driving voltage Vc, driving voltage Vm and driving voltage Vy, where Vc is the smallest and Vy is the largest.

The correspondence table 14B is, as shown in FIG. 5, a region that stores the display color information indicating the color of an image to be displayed on the image display medium 12, the sequence information, the particle color information, and the polarity information in order that they correlate with each other.

As described above with reference to FIG. 3, a white color displayed on the image display medium 12 shown as (A) can be changed to black, blue or cyan can be carried out by applying a voltage at one time. On the other hand, in order to display a green color shown as (D) from the state of displaying a white color shown as (A), steps of displaying a black color shown as (B) and displaying a yellow color shown as (C) are carried outy.

Accordingly, the particle color information includes information indicating the particles that need to be moved to display the intended color, and information indicating the particles that need to be moved to display the color to be displayed prior to displaying the intended color.

The sequence information indicates the sequence of displaying the color corresponding to the above particle color information.

The polarity information is either one of positive electrode information indicating a positive electrode, or negative electrode information indicating a negative electrode. In this exemplary embodiment, when the polarity information is positive electrode information, it indicates that the surface electrode 40 is a positive electrode and the rear electrode 46 is a negative electrode. On the other hand, when the polarity information is negative electrode information, it indicates that the surface electrode 40 is a negative electrode and the rear electrode 46 is a positive electrode. The setting may be designed in an opposite manner.

The definition of the particle color information has been given in connection with the above-mentioned correspondence table 14A, so the explanation thereof is omitted herein.

In the example shown in FIG. 5, the correspondence table 14B is composed of four sections of “display color”, “sequence”, “4particle color” and “polarity”.

In this exemplary embodiment, the section “display color” stores information about seven colors of “black”, “blue”, “cyan”, “magenta”, “yellow”, “red” and “green”, which can be displayed by combining the colors of the particles.

The “sequence” section stores information of “1” representing the earliest order, “2” representing the order next to “1”, and “3” representing the order next to “2”.

The “particle color” section stores information indicating the color of the particles necessary for producing the corresponding display color. In this exemplary embodiment, one ore more of information “Y” representing a yellow color, “M” representing a magenta color, and “C” representing a cyan color are stored in correlation with the sequence information.

The “polarity” section stores information indicating “positive electrode” or “negative electrode”.

The operation of the writing device 17 will be described below with reference to FIG. 6.

FIG. 6 is a flowchart showing a flow of an image display program executed by the control unit 18 to display an image of a specified color on the display medium 12. The image display program is, as described above, originally stored in a predetermined region in the ROM (not shown) of the control unit 18, and is executed by the CPU in the control unit 18 (not shown) by reading the program.

In step 100, whether the display image information has been obtained from the acquisition unit 15 or not is determined. If the result is NO, the routine is terminated, and if YES, the routine proceeds to step 102, and the obtained display image information is stored in the storage unit 14.

In the subsequent step 104, as an initial movement, initial voltage information is read from the storage unit 14. The initial voltage information includes the voltage information, voltage application time information, and polarity information.

In the subsequent step 106, an initial operation signal is output to the voltage application unit 16. The initial operation signal indicates application of a voltage according to the voltage level information included in the initial voltage information, for a period of the voltage application time as indicated by the voltage application time information, and according to the polarity indicated by the polarity information, in such as manner that the surface electrode 40 serves as a negative electrode and the rear electrode 46 serves as a positive electrode.

The voltage application unit 16 that has received the initial operation signal applies a voltage between the surface electrode 40 as the negative electrode and the rear electrode 46 as the positive electrode, for a period of the voltage application time according to the voltage level information included in the initial operation signal.

When the voltage is applied between the substrates in step 106, the particles 34 of all the three colors that are negatively charged move toward and reach the rear substrate 22.

At this time, the color of the image display medium 12 visually recognized from the display substrate 20 side is white that is the color of the insulating particles 36 in the dispersion medium 50.

In the subsequent step 108, the maximum value of the sequence information corresponding to the display color information included in the display image information obtained in the aforementioned step 100 is read from the correspondence table 14B.

In step 108, for example, when the display image information-obtained in step 100 contains display color information that indicates a red color, “2” is read from the table as the maximum value of the sequence information “1” and “2” which are correlated to the “red” information in the display color section.

Alternatively, for example, when the display image information obtained in step 100 contains display color information that indicates a cyan color. “1” is read from the table as the maximum value of the sequence information corresponding to the “cyan” information in the display color section.

In the subsequent step 110, whether the maximum value of the sequence information obtained in the aforementioned step 108 is “1” or not is determined. Accordingly, through the process carried out in step 110, whether the number of the sequence information corresponding to the display color information is one or more is determined.

If the result of the above determination in step 110 is YES (the maximum value is “1”), the routine proceeds to step 112, and if the result is NO (the maximum value is not “1”) the routine proceeds to step 120.

In step 120, the counter value is initialized by setting the counter value N of the counter 14C, which is originally provided in the storage unit 14, to “1”.

In the subsequent step 122, all of the particle color information and the polarity information corresponding to the sequence information corresponding to the display color information contained in the display image information obtained in step 100 is read out. In the subsequent step 124, the driving voltage information corresponding to the obtained particle color information is read out from the correspondence table 14A.

In the subsequent step 126, the maximum value of the driving voltage that has been read out in step 124 is read out.

In the subsequent step 128, a voltage application signal is output to the voltage application unit 16, which signal indicates application of the maximum driving voltage obtained in the above step 126, according to the polarity information obtained in the above step 122, for a period of the time as specified by the voltage application time information originally stored in the storage unit 14.

In the subsequent step 132, whether the counter value of the counter 14C is identical with the maximum value information obtained in the above step 108 is determined, and if the result is NO (the counter value is not the maximum value of the sequence information), the routine goes back to step 122, and if YES (the counter value is the maximum value of the sequence information), the routine proceeds to step 112.

For example, in step 132, if it is determined that the counter value N is 1 and the display image information obtained in step 100 contains the display color information indicating a red color, particle color information of “Y, M, C” that corresponds to the sequence information “1” out of “1” and “2” in the “sequence” section corresponding to the “red” information in the “display color” section is read out in step 122.

Then, in the subsequent step 124, the driving voltage Vy, which is the maximum value among the driving voltages corresponding to the particle color information “Y”, “M”, and “C”, is read from the correspondence table 14A. In the subsequent step 128, a voltage application signal is output to the voltage application unit 16, which signal indicates application of a voltage according to the obtained driving voltage Vy in a positive polarity for a specified period.

Consequently, in the image display medium 12, particles 34 of all colors move to the side of the display substrate 20, turning the state of displaying a white color shown as (A) in FIG. 3 into a state of displaying a black color shown as (B) in FIG. 3.

On the other hand, if the result of the determination in step 110 is YES, or if the result of the determination in step 132 is YES, the routine proceeds to step 112, where information regarding one or more of particle colors and the polarity information corresponding to the maximum value of the sequence information obtained in step 108 are read from the correspondence table 14B.

In the subsequent step 114, the driving voltage information corresponding to the information about one or more particle colors obtained in step 112 is read from the correspondence table 14A.

In the subsequent step 115, the maximum driving voltage information is read from the driving voltage information obtained in the above step 114.

In the processing carried out in steps from 112 to 116, for example, when the display color information indicating a red color is contained in the display image information obtained in step 100, the particle color information “cyan” corresponding to the maximum value “2” of the sequence information obtained in step 108 is read out, and then the driving voltage corresponding to the obtained particle color information “cyan” is read out from the correspondence table 14A.

In the subsequent step 118, a voltage application signal is output to the voltage application unit 16, which signal indicates application of a driving voltage according to the driving voltage information obtained in step 116, in a polarity according to the polarity information obtained in step 112 for a period of the above-specified voltage application time. As the voltage application signal, a pulse signal may be used which having a pulse width and a potential that are adjusted so as to indicate the voltage application time, the voltage, and the polarity.

The voltage application unit 16 that has received the voltage application signal applies a driving voltage determined by the driving voltage information contained in the voltage application signal for a period of the application time according to the application time information, between the surface electrode 40 serving as a negative or positive electrode and the rear electrode 46 serving as a positive or negative electrode, based on the polarity information contained in the voltage application signal, and then terminates the routine.

Through the process of applying a voltage as described above, the display color according to the display image information obtained in step 100 is displayed on the image display medium 12.

As mentioned above, according to this exemplary embodiment, a desired color can be displayed on the image display medium by moving the particles 34 of an intended color by applying a voltage corresponding to the voltage for moving the particles of the intended color between the substrates, thereby providing an image display medium, an image display device and a rewriting device that are capable of displaying a high-quality color image without causing color intermixing.

Further, the particles 34 of plural kinds having different colors and voltages for moving are regulated to be dispersed in the dispersion medium 50 by preparing two predetermined values of intensity of binding force that contribute to the voltage for moving and two predetermined values of intensity of electrostatic force that also contribute to the voltage for moving, and by combining these values. In this manner, the particles 34 having different voltages for moving may be readily prepared.

In the above exemplary embodiment, the particles 34 of plural kinds dispersed in the dispersion medium 50 are described as having the same polarity, but they may have different polarities.

When one or more kind of the particles 34 has a different polarity from the rest of the particles 34, a high-quality color image may be displayed without color intermixing as long as the color and the voltage for moving of each kind of particles are different, by storing in advance information regarding a value of driving voltage, polarity or display sequence for displaying each color in accordance with the value of voltage for moving of each kind of particles 34 by preparing the aforementioned tables 14A and 14B, and by carrying out the process routine as described with reference to FIG. 6.

### Second Exemplary Embodiment

In the first exemplary embodiment, the particles 34 dispersed in the dispersion medium 50 in the image display medium 12 are described as being composed of particles of three colors of yellow, magenta and cyan. In this exemplary embodiment, the particles 34 are described as being composed of particles of four colors of yellow, magenta, cyan and black.

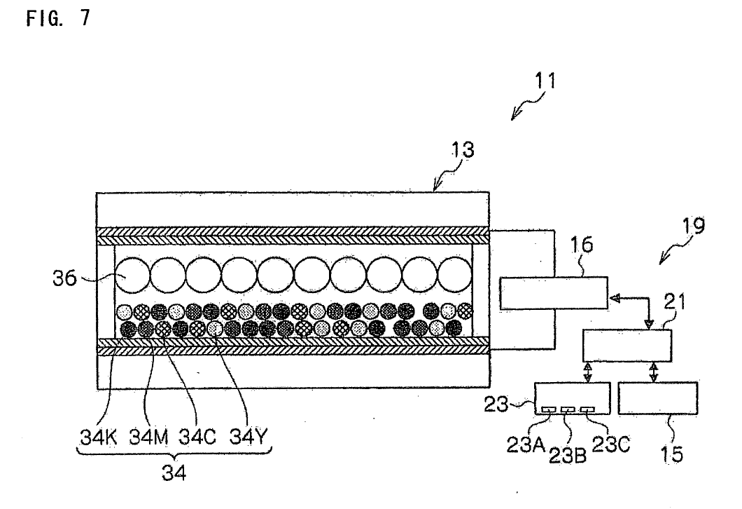

As shown in FIG. 7, an image display medium 13 according to the second exemplary embodiment of the invention includes a display substrate 20 that serves used as an image display surface, a rear substrate 22 disposed opposite to the display substrate 20 with a space, a space member 24 that maintains a predetermined amount of the space and divides the space between the display substrate 20 and the rear substrate 22 into plural cells, a dispersion medium 50 enclosed in each of the cells, and particles 34 and insulating particles 36 dispersed in the dispersion medium 50.

The display substrate 20 has a structure in which a surface electrode 40 and a surface layer 42 are layered on a supporting substrate 38 in this order The rear substrate 22 has a structure in which a rear electrode 46 and a surface layer 48 are layered on a supporting substrate 44 in this order.

The image display medium 13, image display device 11 and rewriting device 19, which will be described later, may have structures similar to those of the image display medium 12, image display device 10 and rewriting device 17 as shown in the first exemplary embodiment, respectively. Therefore, the equivalent parts are provided with the identical numerals, and the detailed explanations thereof will be omitted.

In the dispersion medium 50, the particles 34 of plural kinds having different colors and different absolute values of a voltage that is necessary for the particles to move between the display substrate 20 and the rear substrate 22 are dispersed.

The voltage for moving, as described in the first exemplary embodiment, is determined by a difference between an electrostatic force that acts on the particles 34 and a binding force that acts to bind the particles 34 to a state before the electrostatic force acts on the particles 34. More specifically, the value of the voltage for moving is obtained by subtracting the binding force from the electrostatic force.

Since the voltage for moving has been described in detail in the first exemplary embodiment, explanation thereof will be omitted in this section.

In the first exemplary embodiment, plural kinds of the particles 34 are regulated to have different values of voltage for moving from each other by preparing two different values of intensity of binding force and two different values of intensity of electrostatic force and combining these values. However, in this exemplary embodiment, the combination of the binding force and the electrostatic force is not limited to the above. Namely, the particles 34 of plural kinds having different voltages for moving may be prepared by adjusting the two values of either one of the binding force or electrostatic force while using only one value of the rest, or may be prepared by adjusting three or more values of the binding force or electrostatic force.

Since the properties of the particles 34 that contribute to the binding force and the electrostatic force has been described in detail in the first exemplary embodiment, explanation thereof will be omitted in this section.

In this exemplary embodiment, metal colloid particles having a property of forming a color due to a plasmon effect as described in the first exemplary embodiment may also be used as the particles 34.

In this exemplary embodiment, the insulating particles 36 are described as being white. The structure of the insulating particles 36 are the same as those discussed in the first exemplary embodiment.

The image display medium 13 may be used for bulletin boards, circulars, electronic blackboards, advertisements, signboards, blinking markers, electronic paper, electronic newspaper, electronic books, and document sheets that can also be used for a copier or printer, on which storing or rewriting of images can be performed.

The image display medium 13 displays different colors by changing the value of a voltage to be applied between the display substrate 20 and the rear substrate 22. Namely, by moving each kind of the particles 34 by means of an electric field formed between the substrates, a color corresponding to each pixel of image data can be displayed in each cell corresponding to each pixel of the image display medium 13.

As described above, each kind of the particles 34 moves upon application of a voltage of its own absolute value. Further, as described in the first exemplary embodiment, each kind of the particles 34 has its own range of the voltage for moving that is necessary for the particles to move.

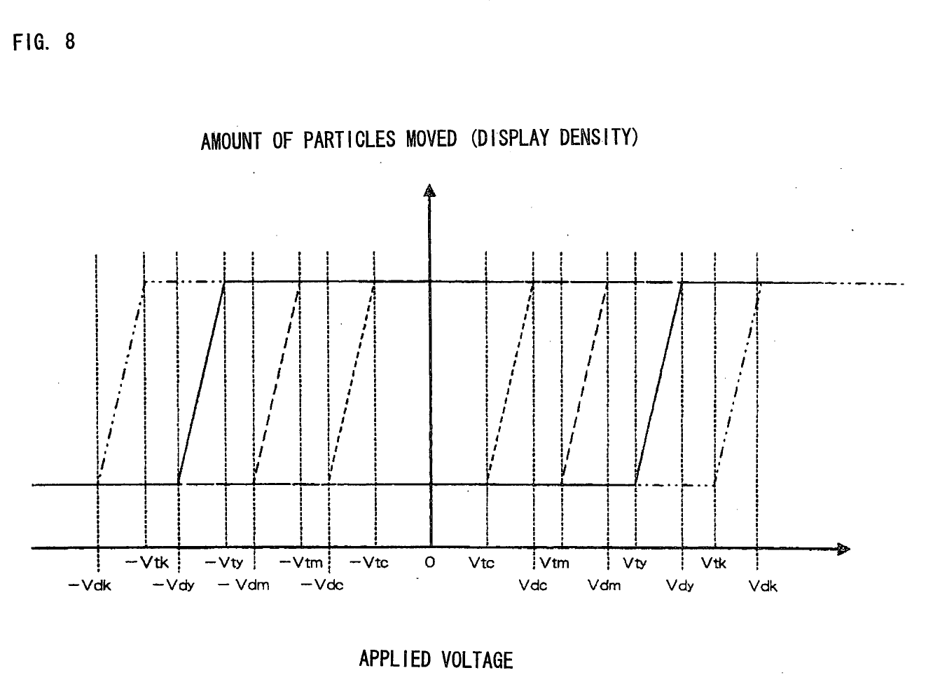

Next, the relationship between the intensity of an electric field and a change in display density due to the movement of the particles 34 of each color between the substrates, in the case of the plural kinds of particles 34 used in the image display medium 34 in this exemplary embodiment, will be described with reference to FIG. 8.

In this exemplary embodiment, as shown in FIG. 7, magenta particles 34M with a magenta color, cyan particles 34C with a cyan color, yellow particles 34Y with a yellow color, and black particles 34K with a black color are enclosed as the particles 34 in the same cell of the image display medium 13.

In the following, the absolute values of the voltage values represented by Vtc, −Vtc, Vdc, −Vdc, Vtk, −Vtk, Vdk, −Vdk, Vtm, −Vtm, Vdm, −Vdm, Vty, −Vty, Vdy, and −Vdy are described as satisfying the relationship of |Vtc|<|Vdc|<|Vtk|<|Vdk|<|Vtm|<<Vdm|<|Vty|<|Vdy|.

Further, as shown in FIG. 7, absolute values of the voltage at which magenta particles 34M, cyan particles 34C, yellow particles 34Y and black particles 34K start to move are expressed by |Vtm|, |Vtc|, |Vty| and |Vtk| respectively. Absolute values of saturation voltage, at which a change in display density stops to occur even when the voltage and the application time thereof applied between the substrate are increased from the commencement of the movement of the particles 34 of each color, i.e., the display density is saturated, of magenta particles 34M, cyan particles 34C, yellow particles 34Y and black particles 34K are expressed by |Vdm|, |Vdc|, |Vdy| and |Vdk|, respectively.

When a voltage is applied between the display substrate 20 and the rear substrate 22 and is gradually increased from 0 V to exceed +Vtc, a change in display density starts to occur due to the movement of the cyan particles 34C in the image display medium 13. When the voltage applied between the substrates is further increased to exceed +Vdc, the change in display density due to the movement of the cyan particles 34C in the image display medium 13 stops.

When the voltage applied between the display substrate 20 and the rear substrate 22 is further increased to exceed +Vtk, a change in display density starts to occur due to the movement of the black particles 34K in the image display medium 13. When the voltage is further increased to exceed +Vdk, the change in display density due to the movement of the black particles 34K in the image display medium 13 stops.

When the voltage applied between the display substrate 20 and the rear substrate 22 is further increased to exceed +Vtm, a change in display density starts to occur due to the movement of the magenta particles 34M in the image display medium 13. When the voltage is further increased to exceed +Vdm, the change in display density due to the movement of the magenta particles 34M in the image display medium 13 stops.

When the voltage applied between the substrates is further increased to exceed +Vty, a change in display density starts to occur due to the movement of the yellow particles 34Y in the image display medium 13. When the voltage is further increased to exceed +Vdy, the change in display density due to the movement of the yellow particles 34Y in the image display medium 13 stops.

On the other hand, when a negative-electrode voltage is applied from 0 V between the display substrate 20 and the rear substrate 22 and gradually increased to exceed the absolute value of −Vtc, a change in display density starts to occur due to the movement of the cyan particles 34C between the substrates in the image display medium 13. When the absolute value of the voltage level is further increased to exceed the absolute value of −Vdc, the change in display density due to the movement of the cyan particles 34C in the image display medium 13 stops.

When the absolute volume of the applied negative-elctrode voltage is further increased to exceed the absolute value of −Vtk, a change in display density starts to occur due to the movement of the black particles 34K in the image display medium 13. When the absolute value of the voltage is further increased to exceed the absolute value of −Vdk, the change in display density due to the movement of the black particles 34K in the image display medium 13 stops.

When the absolute volume of the applied negative-elctrode voltage is further increased to exceed the absolute value of −Vtm, a change in display density starts to occur due to the movement of the magenta particles 34M in the image display medium 13. When the absolute value of the voltage is further increased to exceed the absolute value of −Vdm, the change in display density due to the movement of the magenta particles 34M in the image display medium 12 stops.

When the absolute value of the applied negative-electrode voltage is further increased to exceed the absolute value of −Vty, a change in display density starts to occur due to the movement of the yellow particles 34Y in the image display medium 13. When the absolute value of the voltage is further increased to exceed the absolute value of —Vdy, the change in display density due to the movement of the yellow particles 34Y in the image display medium 13 stops.

Namely, in this exemplary embodiment, as shown in FIG. 8, when a voltage at which a potential difference is in a range of from −Vtc to +Vtc is applied between the display substrate 20 and the rear substrate 22, no movement of the particles 34 (cyan particles 34C, magenta particles 34M, and yellow particles 34Y and black particles 34K) that may cause a change in display density of the image display medium 13 occurs.

When a voltage with an absolute value not less than the absolute values of +Vtc and −Vtc is applied between the substrates, movement of only the cyan particles 34C among the particles 34 of four colors that can cause a change in display density of the image display medium 13 occurs. When a voltage with an absolute value of not less than the absolute values of +Vdc and −Vdc is further applied between the substrates, the chance in display density due to the movement of the cyan particles 34C per unit voltage stops.

When a voltage of not less than the absolute values of −Vtk and +Vtk and less than the absolute values of −Vdk and +Vdk is applied between the display substrate 20 and the rear substrate 22, movement of the black particles 34K among the particles 34 of four colors that can cause a change in display density of the image display medium 13 occurs. When a voltage with an absolute value of not less than the absolute values of −Vdk and +Vdk is applied between the substrates, the change in display density due to the movement of the black particles 34K per unit voltage stops.

When a voltage of not less than the absolute values of −Vtm and +Vtm and less than the absolute values of −Vdm and +Vdm is applied between the display substrate 20 and the rear substrate 22, movement of the magenta particles 34M among the particles 34 of four colors that can cause a change in display density of the image display medium 13 occurs. When a voltage with an absolute value of not less than the absolute values of −Vdm and +Vdm is applied between the substrates, the change in display density due to the movement of the magenta particles 34M per unit voltage stops.

When a voltage of not less than the absolute values of −Vty and +Vty is applied between the display substrate 20 and the rear substrate 22, movement of the yellow particles 34Y among the particles 34 of four colors that can cause a change in display density of the image display medium 13 occurs. When a voltage with an absolute value of not less than the absolute values of −Vdy and +Vdy is applied between the substrates, the change in display density due to the movement of the yellow particles 34Y per unit voltage stops.

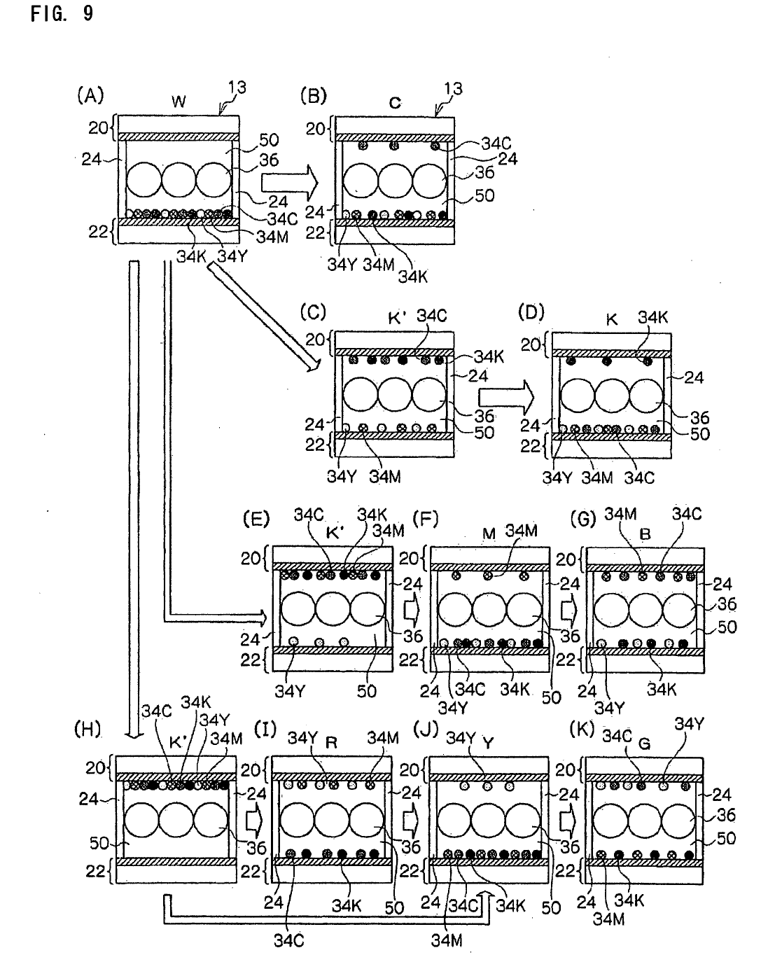

Next, the mechanism of the particle movement when an image is displayed on the image display medium 13 of the invention will be explained with reference to FIG. 9.

In FIG. 9, yellow particles 34Y, magenta particles 34M, cyan particles 34C and black particles 34K as described with reference to FIG. 8 are enclosed in the image display medium 13 as the particles of plural kinds that initiate moving at different intensities of electric field. For convenience of explanation, only a small number of the particles are described in FIG. 9.

In the following, explanation will be given on the condition that the absolute value of the voltage for moving of black particles 34K is greater than the absolute value of the voltage for moving of the cyan particles 34C, the absolute value of the voltage for moving of magenta particles 34M is greater than the absolute value of the voltage for moving of the black particles 34K, and that that the absolute value of the voltage for moving of yellow particles 34Y is greater than the absolute value of the voltage for moving of the magenta particles 34M, as discussed with reference to FIG. 8. Hereinafter, the voltage that is equal to or greater than the absolute value of the voltage for moving of the cyan particles 34C and less than the absolute value of the voltage for moving of the black particles 34K is referred to as a “first voltage”, the voltage that is equal to or greater than the absolute value of the voltage for moving of the black particles 34K and less than the absolute value of the voltage for moving of the magenta particles 34M is referred to as a “second voltage”, the voltage that is equal to or greater than the absolute value of the voltage for moving of the magenta particles 34M and less than the absolute value of the voltage for moving of the yellow particles 34Y is referred to as a “third voltage”, and the voltage that is equal to or greater than the absolute value of the voltage for moving of the yellow particles 34Y is referred to as a “fourth voltage”.

When a voltage is applied to the display substrate 20 that is higher than a voltage applied to the rear substrate 22 to give a potential difference between the substrates, the aforementioned voltages are referred to as “+first voltage”, “+second voltage”, “+third voltage” and “+fourth voltage”, respectively. On the other hand, when a voltage is applied to the rear substrate 22 that is higher than a voltage applied to the display substrate 20 to give a potential difference between the substrates, the electric field intensities are referred to as “− first voltage”, “−second voltage”, “−third voltage” and “−fourth voltage”, respectively.

As shown in a drawing marked with (A) in FIG. 9, all of the magenta particles 34M, black particles 34K, cyan particles 34C and yellow particles 34Y are positioned on the side of the rear substrate 22 in an initial state. In this state, a color of the insulating particles 36, namely, a white color in this exemplary embodiment, is observed from the side of the display substrate 20.

When a “+first voltage” is applied between the display substrate 20 and the rear substrate 22 from the above initial state (A), only cyan particles 34C move to the side of the display substrate 20. Accordingly, the image display medium 13 displays a cyan color of the cyan particles 34C positioned on the side of the display substrate 20 (see a drawing marked with (B)).

When a “+second voltage” is applied between the display substrate 20 and the rear substrate 22 from the above initial state (A), the cyan particles 34C and black particles 34K move to the side of the display substrate 20. Accordingly, the image display medium 13 displays a black color with a tinge of cyan (fourth black color) due to the existence of the cyan particles 34C and black particles 34K on the side of the display substrate 20 (see a drawing marked with (C)).

When a “−first voltage” is applied between the display substrate 20 and the rear substrate 22 from the above state (C), the cyan particles 34C move back to the side of the rear substrate 22. Accordingly, the image display medium 13 displays a black color with a higher degree of blackness than the forth black color exhibited in the state (C) (first black color) due to the existence of only the black particle 34K on the side of the display substrate 20 (see a drawing marked with (D)).

On the other hand, when a “−third voltage” is applied between the display substrate 20 and the rear substrate 22 from the initial state (A), the cyan particles 34C, black particles 34K and magenta particles 34M move to the side of the display side 20. Accordingly, the image display medium 13 displays a black color with a tinge of blue and a lower decree of blackness than the first black color (second black color) due to the existence of the cyan particles 34C, black particles 34K and magenta particles 34M on the side of the display side 20 (see a drawing marked with (E)).

When a “−second voltage” is applied between the display substrate 20 and the rear substrate 22 from the state (E), the cyan particles 34C and black particles 34K move back to the side of the rear substrate 22. Accordingly, the image display medium 13 displays a magenta color due to the existence of the magenta particles 34M on the side of the display side 20 (see a drawing marked with (F)).

When a “+first voltage” is applied between the display substrate 20 and the rear substrate 22 from the state (F), the cyan particle 34C moves to the side of the display substrate 20. Accordingly, the image display medium 13 displays a blue color as a subtractive mixed color of cyan and magenta, due to the existence of the cyan particle 34C and magenta particles 34M on the side of the display side 20 (see a drawing marked with (G)).

On the other hand, when a “+fourth voltage” is applied between the display substrate 20 and the rear substrate 22 from the initial state (A), all of the cyan particles 34C, magenta particles 34M, yellow particles 34Y and black particles 34K move toe the side of the display substrate 20. These particles do not move from the display substrate 20 even when an applied voltage is turned to 0 V at this state, and the image display medium 13 displays a black color having a higher decree of blackness than the second black color and a lower degree of blackness than the first black color (third black color) which is formed from a combination of black and a subtractive mixed color of cyan, magenta and yellow (see a drawing marked with (H).

When a “−second voltage” is applied between the display substrate 20 and the rear substrate 22 from the state (H), the cyan particles 34C and black particles 34K move to the side of the rear substrate 22. Accordingly, the image display medium 13 displays a red color, which is a subtractive mixed color of magenta and yellow, due to the existence of the magenta particles 34M and yellow particles 34Y on the side of the display side 20 (see a drawing marked with (I)).

When a “−third voltage” is applied between the display substrate 20 and the rear substrate 22 from the state (I), the magenta particles 34M move to the side of the rear substrate 22. Accordingly, the image display medium 13 displays a yellow color due to the existence of the yellow particles 34Y on the side of the display side 20 (see a drawing marked with (J)).

The yellow color may also be displayed by applying a “−third voltage” between the display substrate 20 and the rear substrate 22 from the state (H) in order to move the particles except for the yellow particles 34Y (the magenta particles 34M, black particles 34K and cyan particles 34C) to the side of the rear substrate 22.

When a “+first voltage” is applied between the display substrate 20 and the rear substrate 22 from the state (J), the cyan particles 34C move to the side of the display substrate 20 from the side of the rear substrate 22. Accordingly, the image display medium 13 displays a green color, which is formed by subtractive mixing of cyan and yellow, due to the existence of the cyan particles 34C and yellow particles 34Y on the side of the display side 20 (see a drawing marked with (K)).

As described above, in the image display medium 13 of the invention, plural kinds of particles 34 having different colors and different voltages for moving are enclosed in the dispersion medium 50 between the display substrate 20 and the rear substrate 22, and particles of desired color can be selectively moved by applying a voltage of the corresponding intensity. Therefore, movement of particles of other colors than the desired color in the dispersion medium 50 can be suppressed, thereby reducing intermixing of undesired colors.

Moreover, in this exemplary embodiment, a black color having an even higher degree of blackness can be displayed by dispersing black particles in the dispersing medium 50 in addition to the particles of cyan, magenta and yellow, thereby displaying colors of cyan, magenta, yellow, blue, red, green and black, and white of the insulating particles 36.

In this exemplary embodiment, all of the black particles 34K, magenta particles 34M, cyan particles 34C and yellow particles 34Y have been described as having the same polarity, and the absolute values of voltage for moving of these particles have been described as being in ascending order of the cyan particles 34C (smallest), black particles 34K, magenta particles 34M and yellow particles 34Y (largest). However, the polarity of these particles may be different from each other, and the order of the absolute values of voltage for moving is not limited to the above.

When the particles having different colors and absolute value of voltages for moving of particles 34 have different polarities, or when the absolute values of voltage for moving of these particles are not in the aforementioned order, desired color will be displayed by applying an appropriate voltage between the display substrate 20 and the rear substrate 22 in order to move desired particles, as shown in FIGS. 8 and 9, and detailed explanation will be omitted here.

The image display device according to this exemplary embodiment will be further described below.

As shown in FIG. 2, the image display device 11 according to this exemplary embodiment includes the image display medium 13 and a writing device 19.

The image display device 11 corresponds to the image display device of the invention, the image display medium 13 corresponds to the image display medium of the invention, and the writing device 19 corresponds to the writing device of the invention and the electric field forming unit of the image display device of the invention.

According to this exemplary embodiment, the image display medium 13 is fixed to the image display device 11. However, the image display medium 13 may also be detachably attached to the image display device 11. In this case, a state in which the image display medium 13 is connected to the writing device 19 such that a signal can be communicated can be regarded as a state in which the image display medium 13 is attached to the image display device 11, and a state in which the image display medium 13 is not electrically connected to the writing device 19 can be regarded as a state in which the image display medium is detached from the image display device 11. By employing such a structure, the image display medium 13 can be readily exchanged independent of the image display device 11 and the writing device 19.

The writing device 19 includes a voltage application unit 16, a control unit 21, a storage unit 23, and an acquisition unit 15. The voltage application unit 16, storage unit 23, and acquisition unit 15 are connected to the control unit 21 such that a signal can be communicated.

The voltage application unit 16 corresponds to the voltage application unit of the writing device of the invention, the control unit 21 corresponds to the control unit of the writing device of the invention, and the acquisition unit 15 corresponds to the acquisition unit of the writing device of the invention.

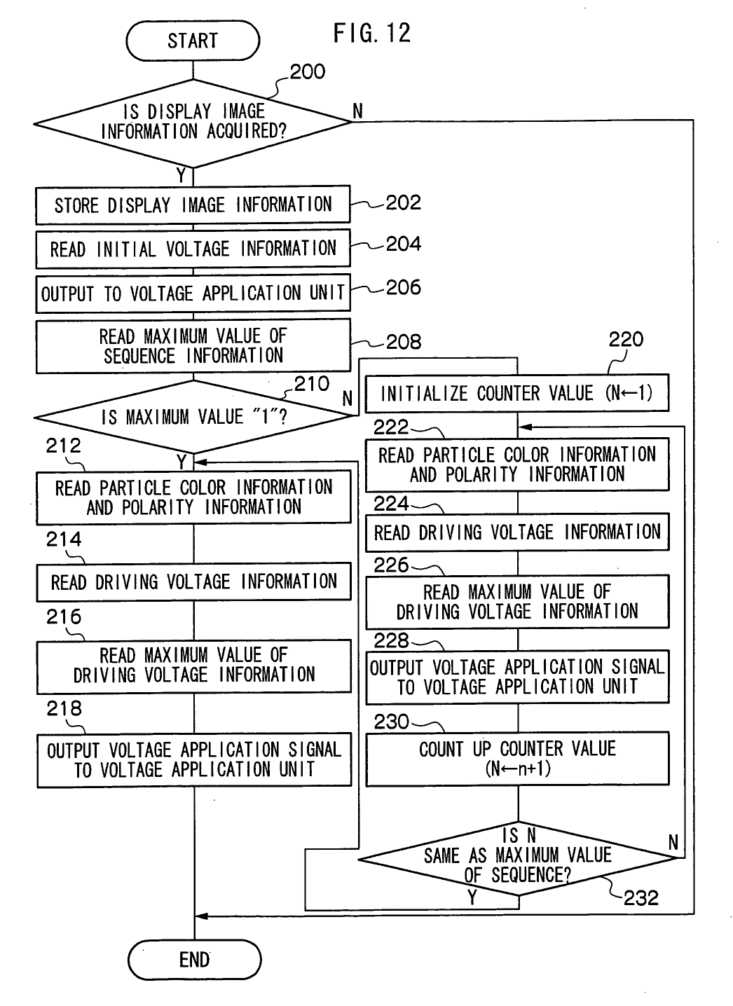

The control unit 21 is constructed as a microcomputer including a CPU (central processing unit) that controls operations of the whole device, an RAM (random access memory) that temporarily stores various kinds of data, and an ROM (read only memory) that stores a control program for controlling the whole device, and various programs including the later-described image displaying program illustrated by a processing routine shown in FIG. 12. The image displaying program may be stored in the ROM in advance, or may be stored in the storage unit 23 in advance.

The voltage applying unit 16 is electrically connected to the surface electrode 40 and the rear electrode 46. In this exemplary embodiment, both the surface electrode 40 and the rear electrode 46 are electrically connected to the voltage applying unit 16. However, it is also possible that either one of the surface electrode 40 and the rear electrode 46 is grounded and the other one is connected to the voltage applying unit 16.

The voltage application unit 16 is a voltage application device that applies a voltage to the surface electrode 40 and the rear electrode 46, which applies a voltage controlled by the control unit 21 between the surface electrode 40 and the rear electrode 46.

The acquisition unit 15 obtains display image information including display color information regarding the color of an image to be displayed on the image display medium 13 (hereinafter may be referred to as display color) from the outside the writing device 19.

The above-mentioned image color and display color correspond to a color phase.

The storage unit 23 originally stores tables such as a correspondence table 12A and a correspondence table 23B, initial voltage information, voltage application time information and other various data, and also newly stores various data.

The initial voltage information includes, as an initial operation prior to displaying an image on the image display medium 13, voltage level information concerning the voltage to be applied between the display substrate 20 and the rear substrate 22 to display a white color, polarity information indicating the polarity of the voltage, and voltage application time information indicating the voltage application time.

The voltage application time information indicates a period of time for voltage application to the space between the substrates of the image display medium 13 to display a chromatic color. In this exemplary embodiment, the voltage application time is described as being constant, but it may also be variable.

In this exemplary embodiment, the voltage of the initial voltage information is determined as a voltage value that exceeds the absolute value of the maximum voltage for moving among the particles 34, in order that all of the particles 34 are moved to the side of the rear substrate 22.

The polarity information is either one of positive electrode information that indicates a positive electrode, or negative electrode information that indicates a negative electrode. In this exemplary embodiment, when the polarity information is positive electrode information, it indicates that the surface electrode 40 is a positive electrode and the rear electrode 46 is a negative electrode. On the other hand, when the polarity information is negative electrode information, it indicates that the surface electrode 40 is a negative electrode and the rear electrode 46 is a positive electrode. The setting may be in an opposite manner.

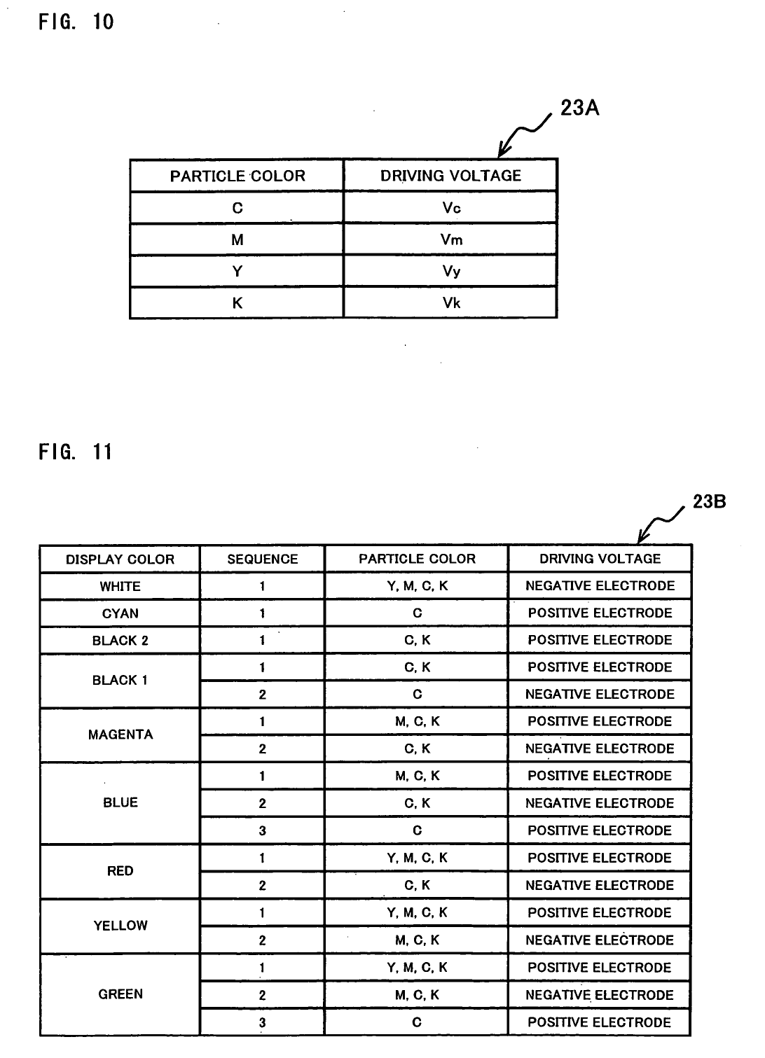

The correspondence table 23A is, as shown in FIG. 10, a region that stores information regarding particle type for distinguishing the particles 34 of different colors from each other, and stores information of the particle color and the driving voltage in order to correlate with each other.

The above-described driving voltage information corresponds to the information that indicates a value of a voltage to be applied between the substrates in order to move the particles 34 of each color, and different values of predetermined voltages corresponding to each color is stored so as to correlate with the particle color information indicating the corresponding color particles of the particles 34.

In this exemplary embodiment, as illustrated in FIG. 8, the storage unit 23 originally stores a driving voltage for the cyan particles 34C (Vc) as a value that is equal to or greater than the absolute value of the voltage for moving of the cyan particles 34C (|Vtc|) and less than the absolute value of the voltage for moving of the black particles 34K (|Vtk|), whose voltage for moving is larger than that of the cyan particles 34C (namely, a voltage within a range in which the cyan particles 34C move).

In a similar manner, as illustrated in FIG. 8, the storage unit 23 originally stores a driving voltage for the black particles 34K (Vk) as a value that is equal to or greater than the absolute value of the voltage for moving of the black particles 34K (|Vtk|) and less than the absolute value of the voltage for moving of the magenta particles 34M (|Vtm|), whose voltage for moving is larger than that of the black particles 34K (namely, a voltage within a range in which the black particles 34K move).

In a similar manner, as illustrated in FIG. 8, the storage unit 23 originally stores a driving voltage for the magenta particles 34M (Vm) as a value that is equal to or greater than the absolute value of the voltage for moving of the magenta particles 34M (|Vtm|) and less than the absolute value of the voltage for moving of the yellow particles 34Y (|Vty|), whose voltage for moving is larger than that of the magenta particles 34M (namely, a voltage within a range in which the magenta particles 34M move).

In a similar manner, as illustrated in FIG. 8, the storage unit 23 originally stores a driving voltage for the yellow particles 34Y (Vy) as a value that is equal to or greater than the absolute value of the voltage for moving of the yellow particles 34Y (|Vty|) (namely, a voltage within a range in which the yellow particles 34Y move).

Consequently, the absolute values of driving voltages for the particles 34 of each color are originally adjusted in the order of the driving voltage Vc, driving voltage Vk, driving voltage Vm and driving voltage Vy, where Vc is the smallest and Vy is the largest.

The correspondence table 23B is, as shown in FIG. 1, a region that stores the display color information indicating the color of an image to be displayed on the image display medium 13, the sequence information, the particle color information, and the polarity information in such a manner that these correlate with each other.

As described above with reference to FIG. 9, a white color initially displayed on the image display medium 13 shown as (A) can be changed to a cyan color by applying a voltage at one time. On the other hand, in order to display a green color shown as (K) from the state of displaying a white color shown as (A), steps of displaying a black color shown as (H), red color shown as (I) and a yellow color shown as (J) are carried out.

Accordingly, the particle color information includes information indicating the particles that need to be moved to display the intended color, and information indicating the particles that need to be moved to display the color to be displayed prior to displaying the intended color.

The sequence information indicates the sequence of displaying the color corresponding to the above particle color information.

The polarity information is either one of positive electrode information indicating a positive electrode, or negative electrode information indicating a negative electrode. In this exemplary embodiment, when the polarity information is positive electrode information, it indicates that the surface electrode 40 is a positive electrode and the rear electrode 46 is a negative electrode. On the other hand, when the polarity information is negative electrode information, it indicates that the surface electrode 40 is a negative electrode and the rear electrode 46 is a positive electrode. The setting may be designed in an opposite manner.

The definition of the particle color information has been given in connection with the above-mentioned correspondence table 23A, so the explanation thereof is omitted herein.

In the example shown in FIG. 11, the correspondence table 213B is composed of four sections of “display color”, “sequence”, “particle color” and “polarity”.

In this exemplary embodiment, the section “display color” stores information about nine colors of “white”, “black 1”, “black 2”, “blue”, “cyan”, “magenta”, “yellow”, “red” and “green”, which can be displayed by combining the colors of the particles. The black 1 and black 2 indicate black colors having different degrees of blackness.

The “sequence” section stores information of “1” representing the earliest order, “2” representing the order next to “1”, and “3” representing the order next to “2”.

The “particle color” section stores information indicating the color of the particles necessary for producing the corresponding display color, In this exemplary embodiment, one or more of the information “Y” representing a yellow color, “M” representing a magenta color, and “C” representing a cyan color are stored in correlation with the sequence information.

The “polarity” section stores information indicating “positive electrode” or “negative electrode”.

The operation of the writing device 19 will be described below with reference to FIG. 12.

FIG. 12 is a flowchart showing the flow of all image display program executed by the control unit 21 to display an image of a specified color on the display medium 13. The image display program is, as described above, originally stored in a predetermined region in the ROM (not shown) of the control unit 21, and is executed by the CPU in the control unit 21 (not shown) by reading the program.

In step 200, whether the display image information has been obtained from the acquisition unit 15 or not is determined. If the result is NO, the routine is terminated, and if YES, the routine proceeds to step 202, and the obtained display image information is stored in the storage unit 23.

In the subsequent step 204, as an initial movement, initial voltage information is read from the storage unit 23. The initial voltage information includes the voltage information, voltage application time information, and polarity information.

In the subsequent step 206, an initial operation signal is output to the voltage application unit 16. The initial operation signal indicates application of a voltage according to the voltage level information included in the initial voltage information, for a period of the voltage application time as indicated by the voltage application time information, and according to the polarity indicated by the polarity information, in such as manner that the surface electrode 40 serves as a negative electrode and the rear electrode 46 serves as a positive electrode.

The voltage application unit 16 that has received the initial operation signal applies a voltage between the surface electrode 40 as the negative electrode and the rear electrode 46 as the positive electrode, for a period of the voltage application time according to the voltage level information included in the initial operation signal.

When the voltage is applied between the substrates in step 206, the particles 34 of all the three colors that are negatively charged move toward and reach the rear substrate 22.

At this time, the color of the image display medium 13 visually recognized from the display substrate 20 side is white that is the color of the insulating particles 36 in the dispersion medium 50.

In the subsequent step 208, the maximum value of the sequence information corresponding to the display color information included in the display image information obtained in the aforementioned step 200 is read from the correspondence table 12B.

In step 208, for example, when the display image information obtained in step 200 contains display color information that indicates a red color, “2” is read from the table as the maximum value of the sequence information “1” and “2” which are correlated to the “red” information in the display color section.

In the subsequent step 210, whether the maximum value of the sequence information obtained in the aforementioned step 208 is “1” or not is determined. Accordingly, through the process carried out in step 210, whether the number of the sequence information corresponding to the display color information is one or more is determined.

If the result of the above determination in step 210 is YES (the maximum value is “1”), the routine proceeds to step 212, and if the result is NO (the maximum value is not “1”), the routine proceeds to step 220.

In step 220, the counter value is initialized by setting the counter value N of the counter 23C, which is originally provided in the storage unit 23, to “1”.

In the subsequent step 222, all of the particle color information and the polarity information corresponding to the sequence information corresponding to the display color information contained in the display image information obtained in step 200 is read out. In the subsequent step 224, the driving voltage information corresponding to the obtained particle color information is read out from the correspondence table 23A.

In the subsequent step 226, the maximum value of the driving voltage that has been read out in step 224 is read out.

In the subsequent step 228, a voltage application signal is output to the voltage application unit 16, which signal indicates application of the maximum driving voltage obtained in the above step 226, according to the polarity information obtained in the above step 222, for a period of the time as specified by the voltage application time information originally stored in the storage unit 23.

In the subsequent step 232, whether the counter value of the counter 23C is identical with the maximum value information obtained in the above step 208 is determined, and if the result is NO (the counter value is not the maximum value of the sequence information), the routine goes back to step 222, and if YES (the counter value is the maximum value of the sequence information), the routine proceeds to step 212.

For example, in step 232, if it is determined that the counter value N is 1 and the display image information obtained in step 100 contains the display color information indicating a red color, particle color information of “Y, M, C, K” that corresponds to the sequence information “1” out of “1” and “2” in the “sequence” section corresponding to the “red” information in the “display color” section is read out in step 222.

Then, in the subsequent step 224, the driving voltage Vy, which is the maximum value among the driving voltages corresponding to the particle color information “Y”, “M”, “C” and “K”, is read from the correspondence table 23A. In the subsequent step 228, a voltage application signal is output to the voltage application unit 16, which signal indicates application of a voltage according to the obtained driving voltage Vy in a positive polarity for a specified period.

Consequently, in the image display medium 13, particles 34 of all colors move to the side of the display substrate 20, turning the state of displaying a white color shown as (A) in FIG. 9 into a state of displaying a black color shown as (H) in FIG. 9.

On the other hand, if the result of the determination in step 210 is YES, or if the result of the determination in step 232 is YES, the routine proceeds to step 212, where information regarding information of one or more of particle colors and polarity information corresponding to the maximum value of the sequence information obtained in step 208 are read from the correspondence table 23B.

In the subsequent step 214, the driving voltage information corresponding to the information about one or more particle colors obtained in step 212 is read from the correspondence table 23A.

In the subsequent step 216, the maximum driving voltage information is read from the driving voltage information obtained in the above step 214.

In the processing carried out in steps from 212 to 216, for example, when the display color information indicating a red color is contained in the display image information obtained in step 200, the particle color information “cyan” corresponding to the maximum value “2” of the sequence information obtained in step 208 is read out, and then the driving voltage corresponding to the obtained particle color information “cyan” is read out from the correspondence table 23A.

In the subsequent step 218, a voltage application signal is output to the voltage application unit 16, which signal indicates application of a driving voltage according to the driving voltage information obtained in step 216, in a polarity according to the polarity information obtained in step 212 for a period of the above-specified voltage application time. As the voltage application signal, a pulse signal may be used which having a pulse width and a potential that are adjusted so as to indicate the voltage application time, the voltage, and the polarity.

The voltage application unit 16 that has received the voltage application signal applies a driving voltage determined by the driving voltage information contained in the voltage application signal for a period of the application time according to the application time information, between the surface electrode 40 serving as a negative or positive electrode and the rear electrode 46 serving as a positive or negative electrode, based on the polarity information contained in the voltage application signal, and then terminates the routine.

Through the process of applying a voltage as described above, the display color according to the display image information obtained in step 200 is displayed on the image display medium 13.

As mentioned above, according to this exemplary embodiment, a desired color can be displayed on the image display medium by moving the particles 34 of an intended color by applying a voltage corresponding to the voltage for moving the particles of the intended color between the substrates, thereby providing an image display medium, an image display device and a rewriting device that are capable of displaying a high-quality color image without causing, color intermixing.

Further, since the image display medium 13 includes particles 34 of four colors of cyan, magenta, yellow and black that move upon application of different voltages, an image having a high degree of blackness can be displayed.

Additionally, by use of the particles of black color, the obtained black color exhibits a higher blackness than that of a color formed by subtractive mixing of cyan, magenta and yellow, and gradation with a favorable gray balance can be readily formed.

In the aforementioned first and second exemplary embodiments, number of colors of the particles are described as three and four, respectively. However, color images of various kinds may also be displayed by using particles of more than four colors in a similar manner to these exemplary embodiments. For example, it is also possible to display pastel colors by using particles having pale colors and particles having dark colors are used in combination, colors with grey tones by using particles having white and other achromatic colors, and hybrid colors of seven colors by using particles of red, green and blue colors.

### EXAMPLES

Hereinafter, the invention will be explained in further details with reference to the examples. Unless otherwise specified, the term “part” refers to “part by weight”.

### Example A1

—Preparation of Particles—

Three types of particles having different colors of cyan, magenta and yellow, and having properties to move at different intensities of an electric field from either one side of the display 20 and the rear substrate 22 to the other side, are prepared as the particles 34.

Example A1 describes a preparation of the image display medium 12 in which yellow particles 34Y, magenta particles 34M, and cyan particles 34C having different average amounts of charge from each other are enclosed, and in which magnetic forces that act on the yellow particles 34Y magenta particles 34M and cyan particles 34C are approximately the same.

—Preparation of Magenta Particles 34M—

Particles having a magenta color are prepared in accordance with the following steps as the magenta particles 34M.

53 parts by weight of cyclohexyl methacrylate, 3 parts by weight of a magenta pigment (trade name: Carmine 6B, manufactured by Dainichiseika Color & Chemicals Manufacturing Co., Ltd.), 3 parts by weight of a charge controlling agent (trade name: COPY CHARGE PSY VP2038, manufactured by Clariant in Japan), and 8.6 parts by weight of magnetite (number average particle size: 0.1 μm, product name: MTS-010, manufactured by Toda Kogyo Corp.), which is coated with a composition in which 50 parts by weight of a magenta pigment (trade name: Carmine 6B, manufactured by Dainichiseika Color & Chemicals Manufacturing Co., Ltd.) is dispersed in 100 parts by weight of an acrylic resin in a thickness of 0.03 μm, are around in a ball mill for 20 hours using zirconia balls having a diameter of 10 mm, thereby obtaining a dispersion liquid A.

Subsequently, 40 parts by weight of calcium carbonate and 60 parts by weight of water are finely ground in a ball mill to obtain a calcium carbonate dispersion liquid B.

4.3 g of 2% carboxymethyl cellulose aqueous solution (2% Cellogen (trade name) aqueous solution), 8.5 g of the above calcium carbonate dispersion liquid B, and 50 g of 20% salt water are mixed and deacrated in an ultrasonic device for 10 minutes, and then stirred in an emulsifier to obtain a mixed solution C.

35 g of the dispersion liquid A, 1 g of divinylbenzene and 0.35 g of a polymerization initiator AIBN are thoroughly mixed and deaerated in an ultrasonic device for 10 minutes, and the obtained mixture is added to the above mixed solution C and emulsified with an emulsifier.

Subsequently, the emulsified liquid is put in a bottle and sealed with a silicone cap, and pressure is reduced by thoroughly removing air using an injection needle, and then the bottle is filled with a nitrogen gas. Reaction is carried out at 60° C. for 10 hours to obtain particles. The obtained particle powder is dispersed in ion-exchanged water to allow the calcium carbonate to decompose with hydrochloric acid water, and the mixture is filtered. Subsequently, the particles are thoroughly washed with distilled water, the particles size is regulated by wet-classification, and then dried. 2 parts by weight of the obtained particles are put in 98 parts by weight of silicone oil (octamethyl trisiloxane) together with 2 parts by weight of a nonionic surfactant, polyoxyethylene alkylether, and stirred and dispersed to obtain a mixed solution.

The polarity of the obtained magenta particles 34M contained in the mixed solution as measured using a pair of parallel-plate electrode is found to be negative.

In this exemplary embodiment, as described above, magnetism can be imparted to each of the magenta particles 34M by including magenta color-coated magnetite as a magnetic material in the particles. The thus obtained magenta particles (magenta particles 34M) have a volume average primary particle size of 1 μm.

—Preparation of Cyan Particles 34C—

Particles having a cyan color are prepared in accordance with the following steps as the cyan particles 34C. The cyan particles are prepared in a similar manner to the magenta particles 34M, except that the magenta pigment is replaced with a cyan pigment (trade name: Cyanine Blue 4933M, manufactured by Dainichiseika Color & Chemicals Mfg. Co., Ltd.), 8.6 parts by weight of the magenta color-coated magnetite is replaced with 4.3 parts by weight of magnetite (number average particle size: 0.1 μm, product name: MTS-010, manufactured by Toda Kogyo Corp.), which is coated with a composition in which 50 parts by weight of a cyan pigment (trade name: Cyanine Blue 4933M, manufactured by Dainichiseika Color & Chemicals Mfg. Co., Ltd.) is dispersed in 100 parts by weight of an acrylic resin in a thickness of 0.03 μm, and the amount of the charge controlling agent (trade name: COPY CHARGE PSY VP2038, manufactured by Clariant in Japan) is changed to 3 parts by weight.

In this exemplary embodiment, as described above, magnetism can be imparted to each of the cyan particles 34C by including cyan color-coated magnetite as a magnetic material.

The obtained cyan particles (cyan particle group 34C) have a volume average primary particle diameter of 1 μm. The polarity of the cyan particle group 34C as measured in a similar maimer to the magenta particle group 34M is found to be negative.

—Preparation of Yellow Particles 34Y—

Particles having a yellow color are prepared in accordance with the following steps as the yellow particles 34Y. The yellow particles are prepared in a similar manner to the magenta particles 34M except that the magenta pigment is replaced with the same amount of a yellow pigment (trade name: Pigment Yellow 17, manufactured by Dainichiseika Color & Chemicals Mfg. Co., Ltd.), the magenta color-coated magnetite is replaced with magnetite (number average particle size: 0.1 μm, product name: MTS-010, manufactured by Toda Kogyo Corp.), which is coated with a composition in which 50 parts by weight of a yellow pigment (trade name: Pigment Yellow 17, manufactured by Dainichiseika Color & Chemicals Mfg. Co., Ltd.) is dispersed in 100 parts by weight of an acrylic resin in a thickness of 0.03 μm, and the amount of the charge controlling agent (trade name: COPY CHARGE PSY VP2038, manufactured by Clariant in Japan) is changed to 1 part by weight.

In this exemplary embodiment, as described above, magnetism can be imparted to each of the particles 34Y by including yellow color-coated magnetite as a magnetic material in the particles. The thus obtained yellow particles (yellow particles 34Y) have a volume average primary particle diameter of 1 μm. The polarity of the yellow particles 34Y as measured in a similar manner to the magenta particle group 34M is found to be negative.

Measurements of the average charge amount that contributes to “electrostatic force” and each of volume average primary particle diameter, quantity of magnetism and shape factor SF1 that contribute to “binding force” of the obtained magenta particles 34M of a magenta color, cyan particles 34C of a cyan color, and yellow particles 34Y of a yellow color are conducted. In addition, relationship between a voltage to be applied and display density is measured using an image display medium prepared by the later-described method, and an absolute value of a potential difference between the substrates for forming an electric field intensity necessary to move each of the magenta particles 34M, cyan particles 34C, and yellow particles 34Y (hereinafter may be referred to as a voltage for moving) and a driving voltage are determined.

The driving voltage is, as described above, a potential difference that is higher than the potential difference between the substrates at which an electric field intensity necessary to move the particles is formed, and is an absolute value of the potential difference equal to or lower than the above-described maximum potential difference for the particles 34 of each color (the potential difference between the substrates at a point at which no more change occurs in display density (get saturated) when a voltage applied between the substrates and a voltage application time are increased from a point at which the particles start to move). The driving voltages shown are values measured at a distance of 40 μm between the display substrate 20 and the rear substrate 22.

The measurement results and setting results are shown in Table 1.

TABLE 1

| | | | | Electrostatic | | | | | | |
|---|---|---|---|---|---|---|---|---|---|---|
| | | | | force | Binding force | | | | | |
| | | | Charge | Average | Volume | | | | | |
| | | Magnetite | controlling | charge | average | | | | | |
| | | content | agent | amount | primary | Quantity of | | | | |
| | Particle | (parts by | (parts by | (×10⁻¹⁷ C/ | particle | magnetism | Shape | | Voltage | Driving |
| | color | weight) | weight) | particle) | diameter (μm) | (emu/g) | factor | Polarity | for moving (V) | voltage (V) |
| Particles 34C | Cyan | 4.3 | 3 | −21 | 1 | 3.9 | 107 | Negative | 5 | 7 |
| Particles 34M | Magenta | 8.6 | 3 | −21 | 1 | 7.8 | 106 | Negative | 10 | 12 |
| Particles 34Y | Yellow | 8.6 | 1 | −7 | 1 | 7.8 | 107 | Negative | 15 | 17 |

As shown in Table 1, in this exemplary embodiment A1, by preparing two different values for binding force and two different values for electrostatic force, and combining these values to determine the value of binding force and electrostatic force for the particles of each color, particles 34 of plural types having different colors and different voltages for moving can be readily prepared.

The average charge amount, volume average primary particle diameter, quantity of magnetism and shape factor SF1 are measured in accordance with the following measuring methods, respectively.

<Method of Measuring Volume Average Primary Particle Size>

When the particles to be measured have a diameter of 2 μm or more, rhe volume average primary particle size is measured with a Coulter Counter TA-II (manufactured by Beckman Coulter) and an electrolyte (trade name: ISOTON-II, manufactured by Beckman Coulter).

The measuring method is as follows. 0.5 mg to 50 mg of a measurement sample is added to 2 ml of a surfactant as a dispersant, preferably a 5% aqueous solution of sodium alkylbenzene sulfonate, and this is added to 100 ml to 150 ml of the electrolyte. The electrolyte in which the sample is suspended is dispersed using an ultrasonic disperser for about 1 minute, and the particle size distribution of the particles having a particle size of 2.0 μm to 60 μm is measured with the Coulter Counter TA-II using an aperture having an aperture diameter of 100 μm. The number of the particles to be measured is 50,000.

Based on the thus measured particle size distribution, a cumulative distribution by volume is drawn from the side of smaller diameter, according to a divided particle size range (channel). The particle diameter at which the accumulation by volume reaches 50% is determined as D50v, which is regarded as the volume average primary particle diameter

On the other hand, when the diameter of the particles to be measured is less than 2 μm, the particles are measured with a laser diffraction particle size distribution meter (trade name: LA-700, manufactured by Horiba, Ltd.). The measuring method is as follows. The sample in a state of dispersion is adjusted to have a solid content of about 2 g, and ion-exchange water is added thereto to make about 40 Ml. The mixture is put in a cell such that the concentration inside thereof is an adequate level, and about two minutes after at which the concentration in the cell is almost stabilized, the measurement is carried out. The thus obtained volume average primary particle size of each channel is accumulated from the smaller volume average primary particle size, and a point at which the accumulation reaches 50% is determined as the volume average primary particle size.

When measurement of powdery products such as an external additive is conducted, 2 g of a measurement sample is added to 50 ml of a surfactant, preferably a 5% aqueous solution of sodium alkylbenzene sulfonate, and this is dispersed in an ultrasonic disperser (1,000 Hz) for two minutes to obtain a sample. Then, the sample is measured in a similar manner to the above-described dispersion liquid.

<Method of Determining Average Charge Amount>

The average charge amount may be determined, for example, by measuring an electrophoresis electric current of a particle having a specified weight. A dispersion liquid in which particles having a specified weight are dispersed is filled in a parallel-plate electrode cell, and a voltage is applied between the parallel-plate electrodes. An electric current at which all of the filled particles move between the electrodes is then measured, and from which an electric charge amount is calculated. The electric charge amount per particle is calculated from the thus calculated electric charge amount and the particle weight. The calculation is carried out on the assumption that the particles have a truly spherical shape and have a uniform diameter.

<Method of Measuring Quantity of Magnetism>

The quantity of magnetism is measured by setting a sample capsule containing 0.2 g of the particles to a vibration-type sample magnetometer (manufactured by Toei Industry Co., Ltd.) and gradually increasing a magnetic field intensity at a temperature of 25° C., and a magnetic susceptibility is measured at a point at which the magnetic field intensity reaches 79.6 kA/m (1 kOe), thereby obtaining a quantity of magnetism as an intensity of the magnetic susceptibility per weight (Am²/kg (emu/g)).

The above process is repeated for three times and the average value is determined as the quantity of magnetism in this exemplary embodiment.

<Method of Determining Shape Factor SF1>

The shape factor SF1 is determined as follows: a microscopic image of the particles observed by a scanning electron microscope (SEM) is imported into a Luzex image analyzer (manufactured by Nireco Co., Ltd.). The maximum length and projected area of at least 50 particles are measured and the number average values thereof are calculated, from which SF1 is obtained based on the following formula (1).

SF1=(ML²/A)×(π/4)×100 Formula (1)

In formula (1), ML represents an absolute maximum length of a particle, and A represents a projected area of a particle.

<Method of Measuring Voltage for Moving>

The voltage for moving is measured as follows: only one kind of the particles prepared as described above are enclosed in the dispersion medium of the image display medium prepared by the later-described method, a voltage is applied between the electrodes, and the density of the display substrate is measured using a densitometer (trade name: X-Rite 964, manufactured by X-Rite). A voltage (or potential difference) corresponding to a threshold at which the density difference between the time points of before and after the density measurement becomes 0.01 or more, with reference to 10 V, is measured as the voltage for moving.

In addition, a voltage at a point at which the measured density gets saturated is measured, and a driving voltage is set as a voltage that is more than the voltage for moving but not more than the voltage at which the measured density is saturated.

—Preparation of Insulating Particles 36—

Particles prepared in accordance with the following steps are used as the insulating particles 36.

53 parts by weight of cyclohexyl methacrylate, 45 parts by weight of titanium oxide (trade name: Tipaque CR63, manufactured by Ishihara Sangyo Kaisha, Ltd.), and 5 parts by weight of cyclohexane are ground in a ball mill together with zirconia balls having a diameter of 10 mm for 20 hours to obtain a dispersion liquid A.

40 parts by weight of calcium carbonate and 60 parts by weight of water are finely ground in a ball mill to obtain a carcium carbonate dispersion liquid B.

4.3 g of 2% carboxymethyl cellulose aqueous solution (Cellogen aqueous solution), 8.5 g of calcium carbonate dispersion liquid, and 50 g of 20% salt water are mixed and deaerated in an ultrasonic device for 10 minutes, and then stirred in an emulsifier to obtain a mixed solution C.

35 g of the above dispersion liquid A, 1 g of divinylbenzene and 0.35 g of a polymerization initiator AIBN (azobisisobutylnitrile) are thoroughly mixed deaerated in an ultrasonic device for 10 minutes. This is added to the above mixed solution C, and this is emulsified with an emulsifier.

Subsequently, the emulsified liquid is put in a bottle and sealed with a silicone cap, and thoroughly deaerated under reduced pressure using an injection needle. The bottle is filled with a nitrogen gas, and reaction is carried out at 60° C. for 10 hours to obtain particles. After cooling, the obtained dispersion is subjected to freeze drying at −35° C., 0.1 Pa for two days to remove cyclohexane. The thus obtained fine particles are dispersed in ion-exchanged water to allow the calcium carbonate to decompose with hydrochloric acid water, and the mixture is filtered. Subsequently, the particles are thoroughly washed with distilled water, the particles size is regulated, and then dried. The obtained insulating particles 36 have a white color and a volume average primary particle size of 10 μm. The measurement of the volume average primary particle size is conducted by the above-described procedure.

—Preparation of Image Display Medium and Image Display Device—

In this exemplary embodiment, the image display medium 12 includes a supporting substrate 38 formed from a transparent conductive ITO supporting substrate of 70 mm×50 mm×1.1 mm, on which plural linear surface electrodes 40 having a width of 0.234 mm are formed at intervals of 0.02 mm by etching. In a similar manner, a supporting substrate 44 is formed from an ITO supporting substrate of 70 mm×50 mm×1.1 mm on which plural linear rear electrodes 46 having a width of 0.234 mm are formed at intervals of 0.02 mm by etching.

A polycarbonate resin is applied onto each of the surface electrode 40 and the rear electrode 46 to a thickness of about 0.5 μm to form a surface layer 42 and a surface layer 48, respectively.

The arithmetic average surface roughness Ra (stipulated in JIS B0601 (1994)) of the surface layer 42 and the surface layer 48 as measured using a laser displacement microscope (trade name: OLS 1100, manufactured by Olympus Corporation) is found to be 0.2 μm.

The display substrate 20 and the rear substrate 22 are thus prepared as above.

Subsequently, a space member 24 with a height of 40 μm is formed on the rear substrate 22. The space member 24 is provided such that a cell (a space surrounded by the space member 24, the display substrate 20 and the rear substrate 22) corresponding to each pixel, when an image is displayed, is formed on the image display medium 12.

The space member 24 is formed to a desired pattern on the rear substrate 22 by photolithography using a photoresist film. The cells are formed in a pattern of squares of 0.254 mm×0.254 mm, in order to substantially correspond to the pixels. The space member 24 may also be formed by applying a heat-curing epoxy resin in a desired pattern to the rear substrate 22 by screen printing, and heat-curing the resin. The process may be repeated for several times to obtain a desired thickness. Alternatively, the space member 24 may be formed by attaching, to the rear substrate 22, a thermoplastic film on which a desired surface texture is formed by injection compression molding, embossing, or hot pressing. Furthermore, the space member 24 may be integrally formed with the rear substrate 22 by embossing or hot pressing. Of course, the space member 24 may be formed on the side of the display substrate 20, or integrally formed with the display substrate 20, as long as the transparency of the substrate is not impaired.

In this exemplary embodiment, silicone oil (IF-96L (trade name), manufactured by Shin-Etsu Chemical Co., Ltd.) is used as the dispersion medium 50.

The yellow particles 34Y, magenta particles 34M and cyan particles 34C prepared as above are dispersed at a volume ratio of 1:1:1 in silicone oil having a viscosity of 1 cs (KF-96L (trade name), manufactured by Shin-Etsu Chemical Co., Ltd.), at a density of 8 parts by weight with respect to 100 parts by weight of the silicone oil. At the same time, a dispersion liquid dispersing 10 parts by weight of the insulating particles 36 is put on the rear substrate 22 with the space member 24 formed thereon, and the dispersion liquid containing mixed particles is put in each cell (each space divided by the space member 24).

The insulating particles 36 are mixed with the dispersion medium 50 at a proportion of 1 to 1 so that the particles are arranged in the cells in a direction perpendicular to a direction in which the display substrate 20 and the rear substrate 22 face with each other, with a space through which the particles 34 can pass, and that the distance between the insulating particles 36 and the display substrate 20 and the distance between the insulating particles 36 and the rear substrate 22 are approximately equal.

The image display medium 12 of the invention can be prepared, as described above, by putting a mixture of the particle 34 of plural kinds, insulating particles 36 and the dispersion medium 50 into cells formed by the space member 24 on the rear substrate 22, placing the display substrate 20 thereon, and then fixing the display substrate 20 and the rear substrate 22 with a clamp or the like.

In this exemplary embodiment, the total volume ratio of the particles 34 to the space volume between the substrates (corresponding to the cell volume) is set about 3%, and the total volume ratio of the insulating particles 36 to the space volume between the substrates is set about 50%.

Electric fields at intensities of 1.3×10⁵ V/m, 2.5×10⁵ V/m and 3.8×10⁵ V/m, respectively, are formed between the display substrate 20 and the rear substrate 22 of the image display medium 12 including magnetized particles having different average charge amount, i.e., the yellow particles 34Y (electric charge amount: −7.0×10⁻¹⁷ C/particle), magenta particles 34M (electric charge amount: −21×10⁻¹⁷ C/particle), and cyan particles 34C (electric charge amount: −21.0×10⁻¹⁷ C/particle). FIG. 2 shows electrostatic forces (N) (electrostatic force by electric field E, F=q·E)) that act on each particle upon application of the respective electric fields.

TABLE 2

| | Electric field intensity | | |
|---|---|---|---|
| Particles | 1.3 × 10⁵ (V/m) | 2.5 × 10⁵ (V/m) | 3.8 × 10⁵ (V/m) |
| Yellow | −0.9 × 10⁻¹¹ (N) | −1.7 × 10⁻¹¹ (N) | −2.6 × 10⁻¹¹ (N) |
| particles | | | |
| Magenta | −2.6 × 10⁻¹¹ (N) | −5.3 × 10⁻¹¹ (N) | −8.0 × 10⁻¹¹ (N) |
| particles | | | |
| Cyan particles | −2.6 × 10⁻¹¹ (N) | −5.3 × 10⁻¹¹ (N) | −8.0 × 10⁻¹¹ (N) |

The voltage for moving of the particles 34 is, as described above, determined as a value obtained by subtracting a value of binding force from a value of electrostatic force. Therefore, for example, when a binding force of 2.6×10⁻¹¹ N is acting on the yellow particles 34Y and cyan particles 34C and a binding force of 5.3×10⁻¹¹ N is acting on the magenta particles 34M, the yellow and cyan particles move upon application of an electrostatic force of more than 2.6×10⁻¹¹ N and the magenta particles move upon application of an electrostatic force of more than 5.3×10⁻¹¹ N.

Namely, when an electric field of more than 3.8×10⁵ V is formed between the substrates, the electrostatic force exceeds the binding force acting on the yellow particles 34Y to move the yellow particles; when an electric field of more than 2.5×10⁵ V is formed between the substrates, the electrostatic force exceeds the binding force acting on the magenta particles 34M to move magenta particles; and when an electric field of more than 1.3×10⁵ V is formed between the substrates, the electrostatic force exceeds the binding force acting on the cyan particles 34C to move cyan particles.

In view of the above, in this exemplary embodiment, the magnetic force that acts on the yellow particles 34Y and cyan particles 34C is set at 2.6×10⁻¹¹ N, and the magnetic force that acts on the magenta particles 344M is set at 5.3×10⁻¹¹ N.

In order to regulate the particles 34 of each color to have a magnetic force as described above, a magnet with an appropriately selected magnetic force may be provided to the display substrate 20 and the rear substrate 22. Materials having a high degree of transparency such as a magnetized resin or a magnetized substrate may be used for the display substrate 20.

As described above with reference to FIGS. 3 and 6, a desired color may be displayed by selectively moving the particles 34 of each color in accordance with the color to be displayed.

In this exemplary embodiment, the electrode on the display substrate 20 of the image display medium 12 is connected to a voltage application unit 16 (trade name: TREK 610C, manufactured by TREK Japan KK) and the electrode on the rear substrate is Grounded. Further, a personal computer having functionalities of control unit 18, storage unit 14 and acquisition unit 15 (trade name: CF-R1, manufactured by Panasonic Corporation) is connected to the voltage application unit 16. The processing program shown in FIG. 6 is stored in the personal computer in advance, and correspondence table 14A containing particles colors and values of driving voltage, as shown in FIG. 4, and correspondence table 14B, as shown in FIG. 5, are stored in a storage area of the personal computer.

In the above-described image display device, the flowchart shown in FIG. 6 is executed by the control unit 18 on each case of obtaining display image information including display color information of cyan, magenta, yellow, black, blue, red or green. As a result, each color of display color information contained in the obtained display image information is displayed on the image display medium 12.

### Example B1

Example B1 describes a preparation of an image display medium in which yellow particles 34Y, magenta particles 34M, cyan particles 34C and black particles 34K are included, compared with Example A1 of an image display medium in which yellow particles 34Y, magenta particles 34M and cyan particles 34C are included.

—Preparation of Magenta Particles 34M—

Particles having a magenta color are prepared in accordance with the following steps as the magenta particles 34M.

40 parts by weight of a copolymer of ethylene (89 mol %) and methacrylic acid (11 mol %) (trade name: NUCREL, manufactured by DuPont), 8 parts by weight of a magenta pigment (trade name: CARMINE 6B, manufactured by Dainichiseika Color & Chemicals Manufacturing Co., Ltd.), 1.6 parts by weight of a charge controlling agent (trade name: COPY CHARGE PSY VP2038, manufactured by Clariant in Japan) are mixed and put in a stainless steel beaker, and the mixture is stirred for one hour while heating to 120° C. in an oil bath to prepare a uniform melt of the thoroughly melt resin, pigment and charge controlling agent. 100 parts by weight of a solvent (trade name: NORPER 15, manufactured by EXXON MOBIL CHEMICAL) is further added thereto. As the temperature of the system decreases, mother particles with a diameter of about 10 to 20 μm containing the pigment and charge controlling agent are separated out. 100 g of the mother particles that had separated out are put in a 01-type attritor and ground using steel balls with a diameter of 0.8 mm.

The grinding is carried out until the volume average particle diameter monitored by a centrifugal precipitation particle distribution meter (trade name: SA-CP 4L, manufactured by Shimadzu Corporation) becomes 1 μm. 20 parts by weight (particle density: 18% by weight) of the obtained condensed particles are diluted with 160 parts by weight of icosane that has been melted by heating at 75° C. in advance, such that the particle density with respect to the whole dispersion is 2% by weight, and the dilution is stirred well.

In this exemplary embodiment, as described above, the flow resistance of each magenta particle with respect to the dispersion medium 50 is adjusted to 83 by applying a voltage of a frequency by which the particles are vibrated.

The volume average primary particle diameter of the obtained magenta particles 34M is 1 μm, and the charge polarity as measured in a similar manner to Example A1 is negative.

—Preparation of Cyan Particles 34C—

Particles having a cyan color are prepared in accordance with the following steps as the cyan particles 34C. The cyan particles are prepared in a similar manner to the magenta particles 34M, except that the magenta pigment is changed to a cyan pigment (trade name: Cyanine Blue 4933M, manufactured by Dainichiseika Color & Chemicals Mfg. Co., Ltd.), and that the amount of the charge controlling agent (trade name: COPY CHARGE PSY VP2038, manufactured by Clariant in Japan) is changed to 3 parts by weight.

In this exemplary embodiment, as described above, the flow resistance of each cyan particle with respect to the dispersion medium 50 is adjusted to 82 by applying a voltage of a frequency by which the particles are vibrated.

The volume average primary particle diameter of the obtained cyan particles 34C is 1 μm, and the charge polarity as measured in a similar manner to Example A1 is negative.

—Preparation of Yellow Particles 34Y—

Particles having a yellow color are prepared in accordance with the following steps as the yellow particles 34Y. The yellow particles are prepared in a similar manner to the magenta particles 34M, except that the magenta pigment is changed to the same amount of a yellow pigment (trade name: Pigment Yellow 17, manufactured by Dainichiseika Color & Chemicals Mfg. Co., Ltd.).

In this exemplary embodiment, as described above, the flow resistance of each yellow particle with respect to the dispersion medium 50 is adjusted to 131 by applying a voltage of a frequency by which the particles are vibrated.

The volume average primary particle diameter of the obtained yellow particles 34Y is 1 μm, and the charge polarity as measured in a similar manner to Example A1 is negative.

—Preparation of Black Particles 34K—

Particles having a black color are prepared in accordance with the following steps as the black particles 34Y. The black particles are prepared in a similar manner to the magenta particles 34M, except that the magenta pigment is changed to a black pigment (trade name: Carbon Black MA11, manufactured by Mitsubishi Chemical Corporation), and that the amount of the charge controlling agent (trade name: COPY CHARGE PSY VP2038, manufactured by Clariant in Japan) is changed to 3 parts by weight.

In this exemplary embodiment, as described above, the flow resistance of each black particle with respect to the dispersion medium 50 is adjusted to 129 by applying a voltage of a frequency by which the particles are vibrated.

The volume average primary particle diameter of the obtained black particles 34K is 1 μm, and the charge polarity as measured in a similar manner to Example A1 is negative.

Measurements of the average charge amount that contributes to “electrostatic force”, each of the volume average primary particle diameter, quantity of magnetism and shape factor SF1 that contribute to “binding force”, and the flow resistance of the particles at the interface with a dispersion medium (octamethyltrisiloxane) of the obtained particles of four colors (magenta particles 34M, cyan particles 34C, yellow particles 34Y and black particles 34K) are conducted.

In addition, an image display medium is prepared in a similar manner to Example A1 using the particles of four colors obtained in the above process. Using the image display medium, a relationship between an applied voltage and display density is measured and a voltage for moving is calculated, and a driving voltage is determined. The results of the measurement and the determined driving voltages are shown in Table 3.

TABLE 3

| | | | Electrostatic | Binding force | | | | | |
|---|---|---|---|---|---|---|---|---|---|
| | | | force | Volume | | | | | |
| | | Charge | Average | average | | | | | |
| | | controlling | charge | primary | | | | | |
| | | agent | amount | particle | | | | | |
| | Particle | (parts by | (×10⁻¹⁷ C/ | diameter | Flow | Shape | | Voltage for | Driving |
| | color | weight) | particle) | (μm) | resistance | factor | Polarity | moving (V) | voltage (V) |
| Particles | Cyan | 2.8 | −20 | 1 | 82 | 107 | Negative | 4.2 | 6.2 |
| 34C | | | | | | | | | |
| Particles | Magenta | 1.2 | −9 | 1 | 83 | 106 | Negative | 9.5 | 12.5 |
| 34M | | | | | | | | | |
| Particles | Yellow | 1.2 | −9 | 1 | 131 | 107 | Negative | 15 | 17 |
| 34Y | | | | | | | | | |
| Particles | Black | 2.8 | −20 | 1 | 129 | 107 | Negative | 6.6 | 8.6 |
| 34K | | | | | | | | | |

The above-described average charge amount, volume average primary particle diameter, quantity of magnetism and shape factor (average value of SF1) are measured in a similar manner to Example A1. The flow resistance is measured in accordance with the following measuring method.

<Method of Measuring Flow Resistance at Interface with Dispersion Medium>

A dispersion medium containing only one kind of particles is prepared and a voltage is applied between electrodes, and a voltage value at which the particles start to move is measured (the dispersion medium here refers to a solvent having the same composition as the solvent used in a mixed solution obtained by mixing three kinds of dispersion media each containing particles of each color). After the particles have gathered to the side of one of the substrates, a voltage is applied in order to move the particles to the side of the other substrate. The measurement is conducted by applying a material having a low surface energy such as a fluorocarbon resin on the surface of the electrode substrate, such that the interaction between the substrates and particles is minimized. A secondary value obtained by multiplying the value of the obtained voltage by the value of the electric charge amount of particles of each color is determined as the flow resistance.

An image display medium 13 is produced in a similar manner to the image display medium 12 produced in Example A1, except that the yellow particles 34Y, magenta particles 34M and cyan particles 34C prepared in Example A1 are changed to the yellow particles 34Y, magenta particles 34M, cyan particles 34C and black particles 34K prepared in the present Example.

Further, an image display device is produced in a similar manner to the image display device produced in Example A1, except that the image display medium 13 is used in place of the image display medium 12.

In this exemplary embodiment, the electrode on the display substrate 20 of the image display medium 13 is connected to a voltage application unit 16 (trade name: TREK 610C, manufactured by TREK Japan KK) and the electrode on the rear substrate is grounded. Further, a personal computer having functionalities of control unit 21, storage unit 23 and acquisition unit 15 (trade name: CF-R1, manufactured by Panasonic Corporation) is connected to the voltage application unit 16. The processing program shown in FIG. 12 is stored in the personal computer in advance, and correspondence table 23A containing particles colors and values of driving voltage as shown in FIG. 10 and correspondence table 23B as shown in FIG. 11 are stored in a storage area of the personal computer.

Electric field at intensities of 1.1×10⁵ V/m, 1.7×10⁵ V/m, 2.4×10⁵ V/m and 3.8×10⁵ V/m, respectively, are formed between the display substrate 20 and the rear substrate 22 of the image display medium 13 including particles having different flow resistances and different average charge amounts, i.e., the yellow particles 34Y (electric charge amount: −9×10⁻¹⁷ C/particle), magenta particles 34M (electric charge amount; −9×10⁻¹⁷ C/particle), cyan particles 34C (electric charge amount: −20×10⁻¹⁷ C/particle) and black particles 34K (electric charge amount: −20×10⁻¹⁷ C/particle). Table 4 shows electrostatic forces (N) (electrostatic force by electric field E, F=q·E)) that act on each particle upon application of each electric field.

TABLE 4

| | Electric field intensity | | | |
|---|---|---|---|---|
| Particles | 1.1 × 10⁵ (V/m) | 1.7 × 10⁵ (V/m) | 2.4 × 10⁵ (V/m) | 3.8 × 10⁵ (V/m) |
| Yellow particles | −1.0 × 10⁻¹¹ (N) | −1.5 × 10⁻¹¹ (N) | −2.1 × 10⁻¹¹ (N) | −3.3 × 10⁻¹¹ (N) |
| Magenta particles | −1.0 × 10⁻¹¹ (N) | −1.5 × 10⁻¹¹ (N) | −2.1 × 10⁻¹¹ (N) | −3.3 × 10⁻¹¹ (N) |
| Cyan particles | −2.1 × 10⁻¹¹ (N) | −3.3 × 10⁻¹¹ (N) | −4.7 × 10⁻¹¹ (N) | −7.4 × 10⁻¹¹ (N) |
| Black particles | −2.1 × 10⁻¹¹ (N) | −3.3 × 10⁻¹¹ (N) | −4.7 × 10⁻¹¹ (N) | −7.4 × 10⁻¹¹ (N) |

The voltage for moving of the particles 34 is, as described above, determined as a value obtained by subtracting a value of binding force from a value of electrostatic force. Therefore, for example, when a binding force of 3.3×10⁻¹¹ N is acting on the yellow particles 34Y and black particles 34C, and a binding force of 2.1×10⁻¹¹ N is acting on the cyan particles 34C and magenta particles 34M, the yellow and black particles move upon application of an electrostatic force of more than 3.3×10⁻¹¹ N, and the cyan and magenta particles move upon application of an electrostatic force of more than 2.1×10⁻¹¹ N.

Namely, when an electric field of more than 1.1×10⁵ V is formed between the substrates, the electrostatic force exceeds the binding force acting on the cyan particles 34C to move the cyan particles; when an electric field of more than 1.7×10⁵ V is formed between the substrates, the electrostatic force exceeds the binding force acting on the black particles 34K to move the black particles; when an electric field of more than 2.4×10⁵ V is formed between the substrates, the electrostatic force exceeds the binding force acting on the magenta particles 34M to move the magenta particles; and when an electric field of more than 3.8×10⁵ V is formed between the substrates, the electrostatic force exceeds the binding force acting on the yellow particles 34Y to move the yellow particles.

In view of the above, in this exemplary embodiment, the flow resistances that act on the yellow particles 34Y and black particles 34K are adjusted to be in a range of from 129 to 131, respectively, and the flow resistances that act on the cyan particles 34C and magenta particles 34M are adjusted to be in a range of from 82 to 83, respectively.

In the above-described image display device, the flowchart shown in FIG. 12 is executed by the control unit 21 in each case of obtaining display image information including display color information of cyan, magenta, yellow, black, blue, red or green. Consequently, each color of display color information contained in the obtained display image information is displayed on the image display medium 13.

From the above result, it is found that Example B1 is also capable of displaying desired colors by selectively moving particles 34 of each color.

Additionally, a degree of blackness displayed on the display substrate 20 side of the image display medium 13 is measured by applying a voltage such that only the black particles 34K are positioned on the side of the display substrate 20.

The blackness is evaluated as a value of L*, which is a lightness index of a color system (L*, a* and b*) proposed by the International Commission on illumination (CIE) in 1976. The L* value is calculated by a colorimeter, X-Rite MODEL 938 (manufactured by X-Rite).

The blackness L* measured after application of a voltage such that only the black particles 34K are positioned on the side of the display substrate 20 is 1. On the other hand, the blackness L* measured when all of the cyan, magenta and yellow particles are moved to the side of the display substrate 20 is 3. Accordingly, it is found that the image display medium 13 produced in Example B1, in which black particles 34K are used, may exhibit a higher degree of black color, compared with the image display medium 12 produced in Example A1.

The degree of blackness may be expressed as reddish black, bluish black, or the like. Accordingly, a black color can be a grayish, dull color, depending on the decree of color saturation (C*). The value of C* is calculated from the following formula.

C*=(a*²+b*²)^{1/2}

In the image display medium 13, the black color expressed only by black particles 34K exhibits a higher degree of blackness than the black color expressed by particles of cyan, magenta and yellow in combination.

All publications, patent applications, and technical standards mentioned in this specification are herein incorporated by reference to the same extent as if each individual publication, patent application, or technical standard was specifically and individually indicated to be incorporated by reference.

What is claimed is:

1. An image display medium comprising:
a pair of substrates placed to face each other with a space therebetween, at least one of the substrates having transparency;
a dispersion medium positioned between the substrates, the dispersion medium having transparency; and
particles of two or more kinds dispersed in the dispersion medium, the particles of each kind being able to move in the dispersion medium in response to an electric field formed between the substrates, each kind of particles having a different color and a different absolute value of a voltage for moving that is necessary for the particles to move,
the voltage for moving being determined from a difference between an electrostatic force that acts on the particles in response to the electric field formed between the substrates and a binding force that acts in a direction of retaining the particles in a state that the particles are in before the electrostatic force acts on the particles,
an intensity of the binding force for the particles of each kind being selected from a predetermined intensity of a first binding force and an intensity of a second binding force that is different from the intensity of the first binding force,
an intensity of the electrostatic force for the particles of each kind being selected from a predetermined intensity of a first electrostatic force and an intensity of a second electrostatic force that is different from the intensity of the first electrostatic force, and
at least one of the intensity of the binding force and the intensity of the electrostatic force for the particles of each kind being different.

2. The image display medium of claim 1, wherein the electrostatic force is determined from an average charge amount per particle of the particles.

3. The image display medium of claim 1, wherein the binding force is determined from at least one selected from the group consisting of a quantity of magnetism per particle of the particles, a volume average primary particle diameter of the particle, and an average shape factor of the particles.

4. The image display medium of claim 1, wherein the particles comprise magenta particles having a magenta color, yellow particles having a yellow color and cyan particles having a cyan color.

5. The image display medium of claim 1, wherein the particles comprise magenta particles having a magenta color, yellow particles having a yellow color, cyan particles having a cyan color, and black particles having a black color.

6. The image display medium of claim 1, farther comprising a reflective member positioned between the pair of substrates, the reflective member having holes through which the particles can pass and having a different reflective property from that of the particles.

7. An image display device comprising an image display medium and an electric field forming unit, the image display medium comprising:
a pair of substrates placed to face each other with a space therebetween, at least one of the substrates having transparency;
a dispersion medium positioned between the substrates, the dispersion medium having transparency; and
particles of two or more kinds dispersed in the dispersion medium, the particles of each kind being able to move in the dispersion medium in response to an electric field formed between the substrates, and each kind of particles having a different color and a different absolute value of a voltage for moving that is necessary for the particles to move,
the voltage for moving being determined from a difference between an electrostatic force that acts on the particles in response to the electric field formed between the substrates and a binding force that acts in a direction of retaining the particles in a state that the particles are in before the electrostatic force acts on the particles,
an intensity of the binding force for the particles of each kind being selected from a predetermined intensity of a first binding force and an intensity of a second binding force that is different from the intensity of the first binding force,
an intensity of the electrostatic force for the particles of each kind being selected from a predetermined intensity of a first electrostatic force and an intensity of a second electrostatic force that is different from the intensity of the first electrostatic force,
at least one of the intensity of the binding force and the intensity of the electrostatic force for the particles of each kind being different, and
the electric field forming unit forming between the substrates an electric field of an intensity corresponding to the particles to be moved.

8. An image display medium comprising:
a pair of substrates placed to face each other with a space therebetween, at least one of the substrates having transparency;
a dispersion medium positioned between the substrates, the dispersion medium having transparency; and
particles of two or more kinds dispersed in the dispersion medium, the particles of each kind being able to move in the dispersion medium in response to an electric field formed between the substrates, and each kind of particles having a different color and a different absolute value of a voltage for moving that is necessary for the particles to move,
at least one kind of the particles being black particles having a black color.

9. The image display medium of claim 8, wherein the particles further comprise magenta particles having a magenta color, yellow particles having a yellow color, and cyan particles having a cyan color.

10. The image display medium of claim 8, wherein the particles of each kind have a different average charge amount per particle.

11. The image display medium of claim 8, wherein the particles of each kind have a different quantity of magnetism per weight.

12. The image display medium of claim 8, wherein the particles of each kind have a different volume average primary particle diameter.

13. The image display medium of claim 8, wherein the particles of each kind have a different average shape factor.

14. The image display medium of claim 8, further comprising a reflective member positioned between the pair of substrates, the reflective member having holes through which the particles can pass and having a different reflective property from that of the particles.

15. An image display device comprising an image display medium and a voltage application unit, the image display medium comprising:
a pair of substrates placed to face each other with a space therebetween, at least one of the substrates having transparency;
a dispersion medium positioned between the substrates, the dispersion medium having transparency; and
particles of two or more kinds dispersed in the dispersion medium, the particles of each kind being able to move in the dispersion medium in response to an electric field formed between the substrates, and each kind of particles having a different color and a different absolute value of a voltage for moving that is necessary for the particles to move,
at least one kind of the particles being black particles having a black color, and
the voltage application unit applying a voltage between the substrates of the image display medium.
